(19) United States
(12) Patent Application Publication
(10) Pub. No.: US 2025/0139133 A1
(43) Pub. Date: May 1, 2025

(54) SCHEMA AND DATA VIEWS OF AN ONTOLOGY

(71) Applicant: PassiveLogic, Inc., Holladay, UT (US)

(72) Inventors: Troy Aaron Harvey, Brighton, UT (US); Jeremy David Fillingim, Salt Lake City, UT (US); Tyler Pollick, Salt Lake City, UT (US); Sarah Schuster-Johnson, Salt Lake City, UT (US)

(21) Appl. No.: 18/498,440

(22) Filed: Oct. 31, 2023

(51) Int. Cl. G06F 16/28

(52) U.S. Cl. CPC G06F 16/287

(57) ABSTRACT

Various embodiments relate to a method, apparatus, and non-tangible machine-readable storage medium including one or more of the following: displaying a first visualization of a schema; receiving a schema component; displaying a second visualization of the schema component; and displaying relationships between the first schema component and the second schema component.

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Various embodiments described herein relate to database display tools and more particularly, but not exclusively, to tools for displaying both a database schema and data associated with an instance of the database.

### BACKGROUND

Designing a user interface for database navigation that is easy to understand for all users, regardless of experience, is a challenging task. Even experienced designers can struggle with this problem. Viewing a database schema and viewing the data within a database are two different approaches to organizing and viewing data in a database. Trying to combine schema and data views has been tried but with little success. A well-designed interface that incorporates both schema and data views in an intuitive way would improve user satisfaction, increase productivity, and reduce errors.

### SUMMARY

According to the foregoing, it would be desirable to provide a method of viewing a schema of a digital twin and data associated with the digital twin in a way that conveys the most information.

Various embodiments described herein relate to a method for displaying a schema on a user interface. This method may include one or more of: displaying a first visualization of a schema; receiving a schema component; displaying a second visualization of the schema component; and displaying relationships between the first schema and the second schema component.

Various embodiments are described where the schema component is a graphical representation.

Various embodiments are described where the graphical representation is an icon.

Various embodiments are described where relationships between the schema and the schema component are represented using connection lines.

Various embodiments are described where the first visualization of the schema component is a hierarchical cluster view of at least a portion of the schema.

Various embodiments are described where the second visualization displays data associated with an instance of the schema.

Various embodiments are described where the receiving a schema component is received from an indication transmitted from a user interface.

Various embodiments are described where the schema is a digital twin schema.

Various embodiments are described where the digital twin schema includes domains, and wherein the domains include objects.

Various embodiments described herein relate to a non-transitory machine-readable medium encoded with instructions for execution by a processor for viewing a schema. The non-transitory machine-readable medium may include one or more of: instructions for displaying a first visualization of the schema; instructions for receiving a schema component associated with the schema; instructions for displaying a second visualization of the schema component; and instructions for displaying a relationship between the schema and the schema component.

Various embodiments described herein relate to instructions for displaying the first visualization of a schema which includes instructions for displaying domains associated with a digital twin associated with the schema.

Various embodiments described herein relate to instructions for displaying the second visualization of the schema component which includes instructions for displaying data associated with an instance of the digital twin.

Various embodiments described herein relate to instructions for displaying relationships between the schema and the schema component which includes displaying at least one data object associated with an instance of the schema, displaying at least one data object associated with an instance of the schema component with a relationship with the schema, and displaying a visual marking of the relationship between the schema and the schema component.

Various embodiments described herein relate to the visual marking of the relationship between the schema and the schema component include displaying a line between the first visual representation and the second visual representation.

Various embodiments described herein relate to the visual marking of the relationship between the schema and the schema component further includes displaying a label indicating a name of the schema and a name of the schema component.

Various embodiments described herein relate to a device for viewing a schema. The device may include one or more of: a memory storing descriptions of the schema for an ontology, and a processor in communication with the memory configured to: display a first visualization of the schema; receive a schema component; display a second visualization of the schema component; and displaying relationships between the first visualization of the schema and the second visualization of the schema component.

Various embodiments described herein relate to the schema including a schema of a digital twin.

Various embodiments described herein include data being in an instance of the digital twin stored in memory, and where the second visualization includes a visualization of at least some of the data in the instance of the digital twin.

Various embodiments described herein include a first schema that includes first schema objects, and the schema component includes second schema objects. Also, when displaying relationships, the processor is configured to draw a line between a display of a first schema object and a display of the second schema objects when there is a relationship between the first schema object and the second schema objects.

Various embodiments described herein include the schema component including a portion of data within an instance graph of a digital twin.

### BRIEF DESCRIPTION OF THE DRAWINGS

In order to better understand various example embodiments, reference is made to the accompanying drawings, wherein:

FIG. 1A illustrates an example system for implementation of various embodiments;

FIG. 1B illustrates an embodiment of a graphical user interface for viewing a schema of an ontology.

FIG. 1C illustrates an embodiment of a graphical user interface for viewing a schema of an ontology.

FIG. 2 illustrates an example device for implementing a digital twin viewing and exploring suite;

FIG. 3 illustrates an example digital twin for construction by or use in various embodiments;

FIG. 4 illustrates an example hierarchy of an ontology;

FIG. 5 illustrates an example of a simple system;

FIG. 6 illustrates some aspects of a domain;

FIG. 7 illustrates examples of some shapes made of vertices;

FIG. 8 illustrates an example floorplan made of vertices;

FIG. 9 illustrates an example viewing and exploring suite;

FIG. 10 illustrates an example surface that has been turned into a 3D object;

FIG. 11 illustrates example surfaces;

FIG. 12 illustrates an embodiment of an instance graph;

FIG. 13 illustrates an embodiment of instance graph with some of the underlying data displayed;

FIG. 14 illustrates an embodiment of instance graph with some of the underlying data displayed;

FIG. 15 illustrates an embodiment of instance graph with some of the underlying data displayed;

FIG. 16 illustrates an embodiment of instance graph with some of the underlying data displayed;

FIG. 17 illustrates an example hardware device for implementing schema and data views of a digital twin ontology; and

FIG. 18 illustrates an example method for implementing schema and data views of a digital twin ontology.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein.

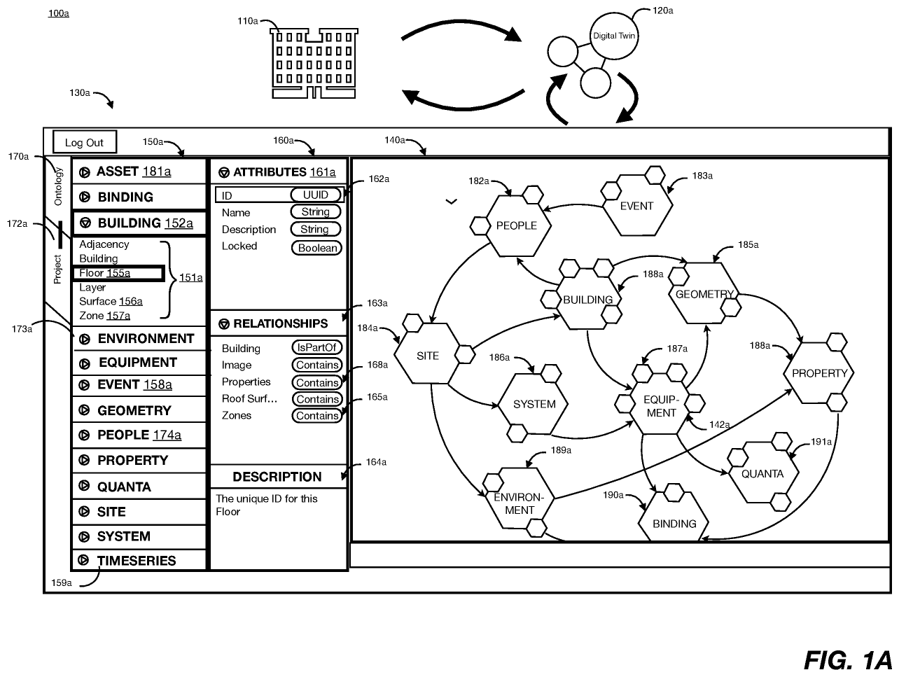

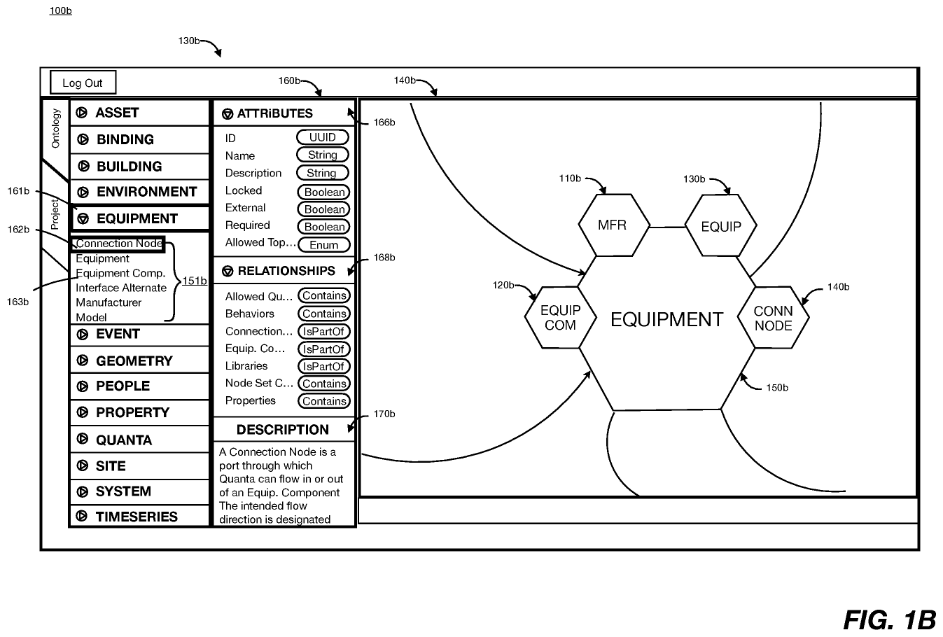

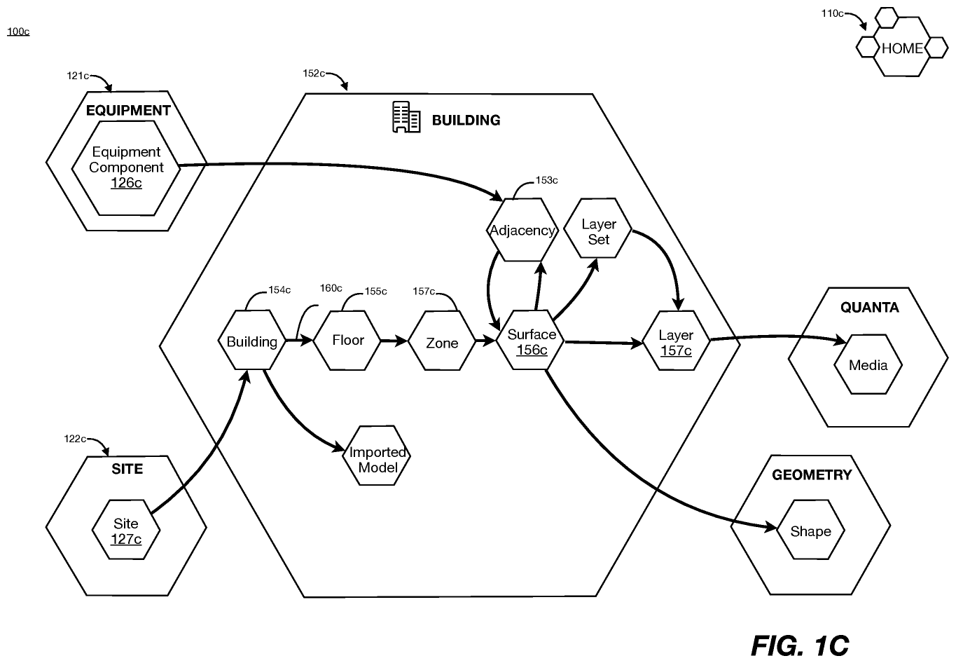

FIG. 1A illustrates one embodiment of a graphical user interface 100a for viewing a schema of an ontology. The dictionary definition of ontology is “the branch of metaphysics dealing with the nature of being”. Rather than being a database that stores a web of interconnected fields, an ontology has extra information which allows individual bits of the ontology to answer questions of “what do I do?”, and “how do I do it?” for the things that are used in and around systems, such as digital twins. Rather than focusing time and attention on “what is this thing called?”, the ontology focuses on more complex questions such as “how do things work quantitatively?” Within this ontology, objects within the ontology may be displayed in various ways. As shown, the system may include an environment 110a, at least some aspect of which is modeled by a digital twin 120a. The digital twin 120a, in turn, interacts with a digital twin ontology graph viewing and exploring suite 130a for providing a user with various means for understanding the makeup of the digital twin 120a and, by doing so, being able to use the digital twin 120a for gaining insights into the real-world environment 110a. According to one specific set of examples, the environment 110a is a portfolio of buildings while the digital twin 120a models various aspects of that portfolio as domains. The domains partition the database schema into related groupings, such as, for example, the people that use the building (people 174a), the environment where the building is located 173a, the building itself including floors, zones, surfaces, layers, etc. (152a), equipment, such as the HVAC equipment need; all which may be characterized with different properties. In an embodiment view, the domains are listed 150a and represented graphically as clusters 140a. These clusters may partition the digital twin ontology into related sections. Some or all of the digital ontology may be so partitioned. Some clusters may be drilled down to more basic schema components. In another view, rather than the schema view, a user may be able to view a specific digital twin terms of its schema, but still view the underlying data as desired. This data-schema view may be able to view portions of the underlying data while retaining a large part of the schema view.

While various embodiments disclosed herein will be described in the context of an building application or in the context of building design and analysis, it will be apparent that the techniques described herein may be applied to other applications including, for example, applications for controlling a lighting system, a security system, an automated irrigation or other agricultural system, a power distribution system, a manufacturing or other industrial system, or virtually any other system that may be controlled. Further, the techniques and embodiments may be applied to other applications outside the context of controlled systems or environments 110a. These controlled systems or environments 110a may be buildings or portfolios of buildings. Virtually any entity or object that may be modeled by a digital twin may benefit from the techniques disclosed herein. Various modifications to adapt the teachings and embodiments to use in such other applications will be apparent.

The digital twin 220 is a digital representation of one or more aspects of the environment 110a. In various embodiments, the digital twin 220 is implemented as a heterogenous, omnidirectional neural network. As such, the digital twin 220 may provide more than a mere description of the environment 110a and rather may additionally be trainable, computable, queryable, and inferencable, as will be described in greater detail below. In some embodiments, one or more processes continually, periodically, or on some other iterative basis adapts the digital twin 120a to better match observations from the environment 110a. For example, the environment 110a may be outfitted with one or more temperature sensors that provide data to a building controller (not shown), which then uses this information to train the digital twin to better reflect the current state or operation of the environment. In this way, the digital twin is a “living” digital twin that, even after initial creation, continues to adapt itself to match the environment 110a, including adapting to changes such as system degradation or changes (e.g., permanent changes such as removing a wall and transient changes such as opening a window).

Various embodiments of the techniques described herein may use alternative types of digital twins than the heterogenous neural network type described in most examples herein. For example, in some embodiments, the digital twin 120a may not be organized as a neural network and may, instead, be arranged as another type of model for one or more components of the environment 110a. In some such embodiments, the digital twin 120a may be a database or other data structure that simply stores descriptions of the system aspects, environmental features, or devices being modeled, such that other software has access to data representative of the real world objects and entities, or their respective arrangements, as the software performs its functions.

The digital twin ontology graph viewing and exploring suite 130a (also referred to as the viewing and exploring suite) is a visual representation of the ontology of the digital twin showing domains, objects within the domains, and relationships between the different domains, between the objects within the same domain and different domains, etc. This ontology graph viewer and explorer may be selected by selecting a tab, such as the ontology tab 170a. For clarity, not all text is shown within the displayed digital twin ontology graph viewing and exploring suite 130a. This viewing and exploring suite may provide a collection of tools for interacting with the digital twin 120a such as, for example, tools for understanding the ontology that makes up the digital twin. The ontology is based on the previously mentioned objects and the relationships between them, where the objects have attributes, all of which may be viewed. It will be understood that while the viewing and exploring suite 130a is depicted here as a single user interface that the viewing and exploring suite 130a includes a mix of hardware and software, including software for performing various backend functions and for providing multiple different interface scenes (such as the one shown) for enabling the user to view representations of the digital twin 120a. As shown, the digital twin viewing and exploring suite 130a provides a visual representation of the ontology of the digital twin showing domains, objects, and their relationships. This visual representation ontology may be used for various purposes such as for understanding the structure of the digital twin that has been created or is in the process of being created. It may also be used as a learning tool to more fully understand how to structure a digital twin 120a.

As shown, the digital twin viewing and exploring suite 130a currently displays a list of ontology domains on left panel 150a. Selecting a domain (e.g., Building 152a) opens up an object browser 151a. The object browser 151a displays the objects associated with a given domain within a drawer that opens up directly below the chosen domain. Selecting an object (e.g., “floor” 155a) within the object browser 151a brings up a details browser 160a. The details browser 160a includes an attributes section 161a which describes the attributes of the object and the type of the attribute. For example, the floor object 155a has an ID attribute type 162a that is type UUID—a unique ID. A relationship section 163a describes the relationships of the object. These relationships may be between other objects within the domain. For example, floor 155a contains zones 165a, which are another object (zone 157a) within the building domain 152a. The floor object 155a also has a relationship with properties 168a. “Property” is an object within the property domain 188a. Some relationships are “Is Part Of”. For example, the floor object 155a “is part of” a building, meaning the building object contains some number of floor objects. Some relationships are “contains”. The floor object 155a may itself contain an image, properties, a roof surface, and zones. When an attribute or relationship is chosen, in some instances, a description section 164a gives a brief description of the attribute of relationship and how it is used. For example, the floor 155a attribute id 162a, description 164a is “The unique ID for this Floor”. An ontology graph explorer 140a includes each domain (e.g. 182a-191a) and some of the objects associated with the domain. Each domain may not be visible in every view of the ontology graph explorer, but controls (not pictured) allow the size and position of the graph to be changed. In some embodiments, these size and position controls may use simple mouse controls such as clicking, press and hold, etc. The user may also be provided with similar controls for changing the domain that is being viewed or the level of detail that is shown within a domain as discussed later.

FIG. 1B is an example of a close-up of an embodiment of a graphical user interface 100b that describes a single domain in the ontology graph explorer 140a, the equipment domain 150b. The detail browser 151b is open showing the objects 151b associated with the equipment domain 161b. The connection node 162b has been selected. As such, the details browser 160b is open, and displays the attributes 166b, relationships 168b, and a description 170b of the connection node 162b. A variety of user interface tools may be employed to allow close-up views as shown here.

The digital twin viewing and exploring suite's 130a current interface scene 140b includes a closeup of the equipment domain ontology 150b. Arranged with reference to the equipment domain ontology are some of the objects associated with the equipment domain, in the case equipment 120b, manufacturer 110b, equipment 130b, and connection node 140b. Different embodiments may include different objects displayed as the equipment domain ontology 150b. Various alternative embodiments will include a different set of panels or other overall graphical interface designs that enable access to the applications, tools, and techniques described herein.

FIG. 1C is an example of a cluster view 100c of a domain within a schema that defines an ontology. When a domain (e.g., 182a-190a) within a current interface scene 140a is selected, various underlying schema representations of the domain may be displayed. These underlying schema representations may include the objects associated with the domain (e.g., 151a). In some embodiments, a screen, such as the cluster view 100c may include an icon 110c that returns the screen to an initial view.

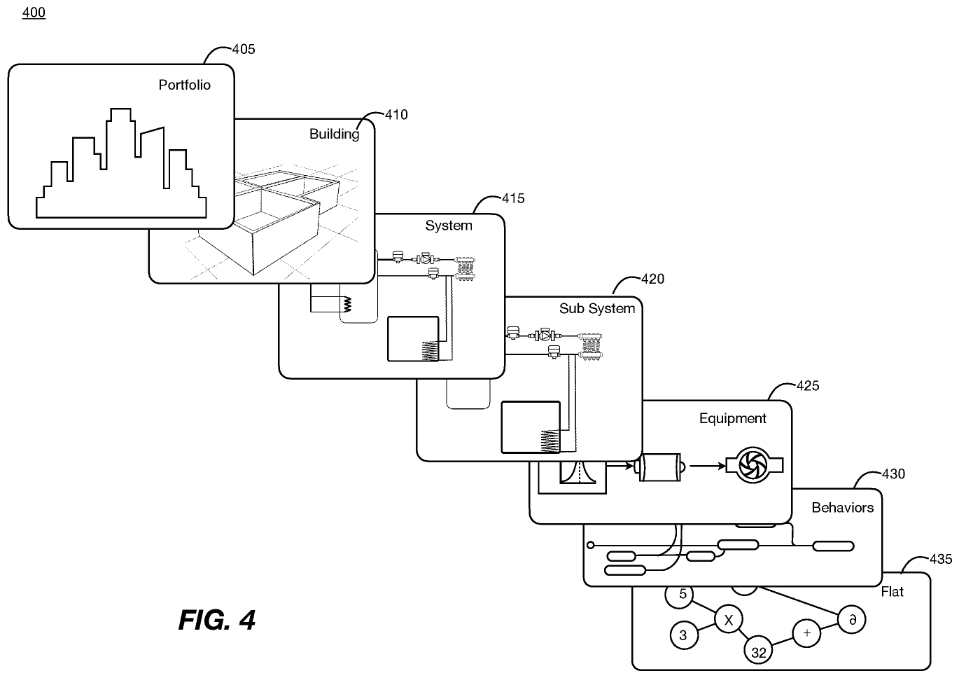

Overall, as discussed, the information model described and viewed using embodiments herein are based on objects and relations. Objects have attributes. An object type represents a modular concept in the ontology described herein. “Ontology” as used herein is focused on answering the questions of “what do I do?”, and “how do I do it?” for the objects that are used within the system we are describing. This moves the focus from questions such as “what is this object called?”, to questions such as “how do these objects work quantitatively?” Some sorts of objects are a building, a floor of a building, a component of a piece of equipment, a medium representing a type of liquid passed between different pieces of equipment, etc. Different types of objects are organized into domains, with the domains grouping the objects in meaningful ways. The domains are arranged roughly hierarchically, and are discussed with greater specificity with reference to FIG. 4.

In the given view, where all domains are visible, primary objects (a subset of all objects) are displayed. Different embodiments may include different primary objects. While the foregoing examples speak of user tools for viewing the digital twin in a wide variety of levels 140a, in various embodiments this functionality occurs by way of creation or modification of the digital twin 120a. That is, when a user interacts with a building workspace to create, e.g., a new zone, a digital twin viewing and exploring suite 130a updates the digital twin 120a to include the objects within the domains, as well as any other appropriate modifications to other aspects of the digital twin (e.g., adding, updating, deleting objects and their associated attributes). Then, once the digital twin 120a is updated, the digital twin viewing and exploring 130a will render the currently displayed portion of the digital twin 120a into the workplace 140a, thereby visually reflecting the changes made by the user. Various other applications for the digital twin viewing and exploring suite 130a will be described below as appropriate to illustrate the techniques disclosed herein.

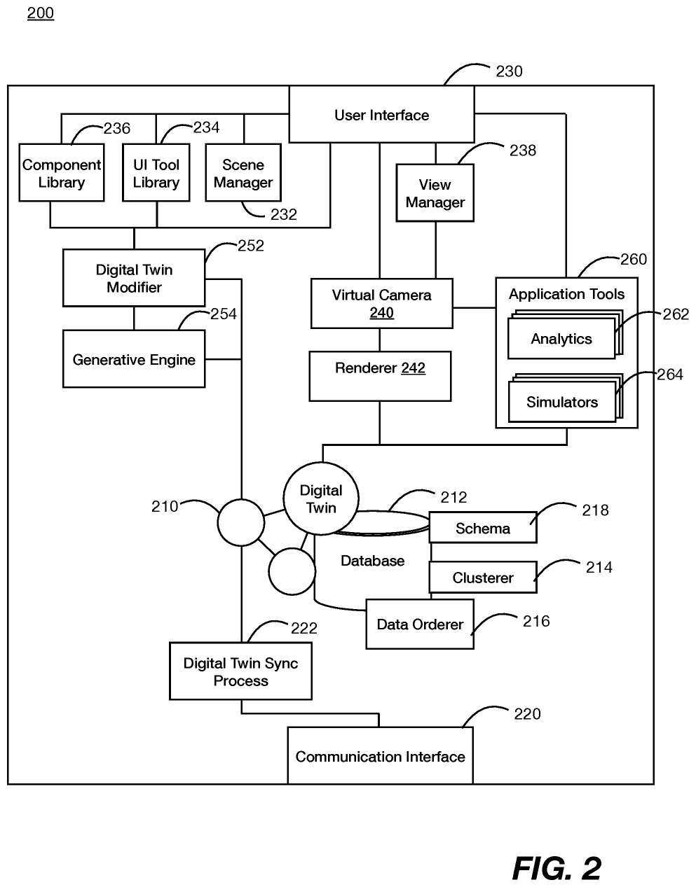

FIG. 2 illustrates an example device for implementing a digital twin viewing and exploring suite 200. The digital twin application device 200 may correspond to the device that provides digital twin viewing and exploring suite 130a and, as such, may provide a user with access to one or more applications for interacting with a digital twin.

The digital twin application device 200 includes a digital twin 210, which may be stored in a database 212. This database may be stored as a schema. A database schema may be a blueprint or structural design that defines the organization, structure, and relationships of data within a database. It may provide a logical view of the entire database, describing how data is organized and how different data elements relate to each other. A database schema may include the following elements: tables, columns, constants, relationships, indexes, etc. Tables are used to store data in a database. Each table represents a specific entity or concept, such as buildings, floors, adjacency, etc. Tables are made up of rows (records) and columns (fields) to store individual pieces of data. Columns represent attributes or properties of the data stored in a table. Columns have a data type that defines the kind of data it can hold, such as text, numbers, dates, or binary data. Relationships: The schema defines how tables in the database are related to each other. Constraints may specify rules or conditions that data must meet to maintain data integrity. Common constraints include unique constraints (ensuring uniqueness of values in a column) and check constraints (specifying allowable values). Indexes: Indexes are used to optimize data retrieval by creating a data structure that allows a database management system to locate and access data in a table. Views may be virtual tables that provide a way to present data from one or more tables in a specific format without changing the underlying data. Cluster views may partition the data into a set number of groups. For example, the domains 150a are clustered views. The connected domains, where individual domains are represented by icons 140a, and where the domain connections are represented using, e.g., lines, are also clustered data. A schema 218 may define how the database is arranged. A clusterer 214 may be used to organize the database schema into clusters. A data orderer 216 may order data within an instance of a digital twin. The instance of the digital twin may be ordered according to the schema.

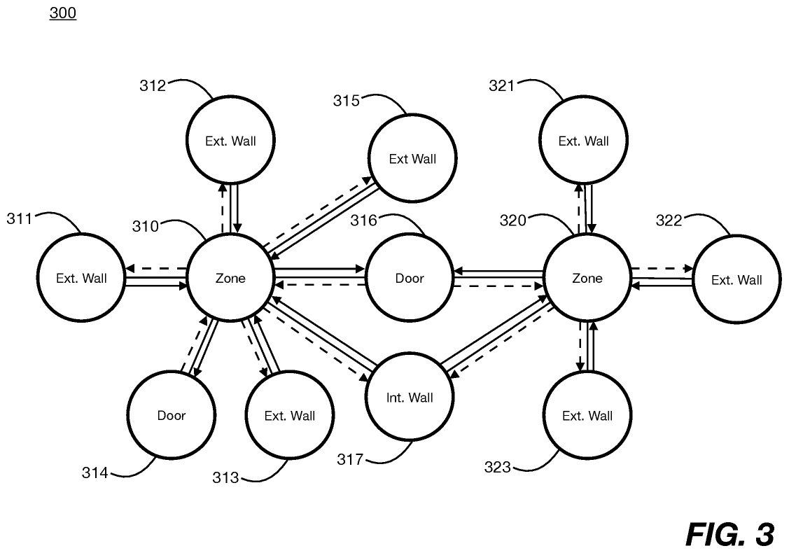

The digital twin 210 may correspond to the digital twin 120a or a portion thereof (e.g., those portions relevant to the applications provided by the digital twin application device 200) The digital twin 210 may be used to drive or otherwise inform many of the applications provided by the digital twin application device 200. A digital twin 210 may be any data structure that models a real-life object, device, system, or other entity. Examples of a digital twin 210 useful for various embodiments will be described in greater detail below with reference to FIG. 3. While various embodiments will be described with reference to a particular set of heterogeneous and omnidirectional neural network digital twins, it will be apparent that the various techniques and embodiments described herein may be adapted to other types of digital twins. In some embodiments, additional systems, entities, devices, processes, or objects may be modeled and included as part of the digital twin 210.

In some embodiments, the digital twin 210 may be created and used entirely locally to the digital twin application device 200. In others, the digital twin may be made available to or from other devices via a communication interface 220. The communication interface 220 may include virtually any hardware for enabling connections with other devices, such as an Ethernet network interface card (NIC), WiFi NIC, or USB connection.

A digital twin sync process 222 may communicate with one or more other devices via the communication interface 220 to maintain the state of the digital twin 210. For example, where the digital twin application device 200 creates or modifies the digital twin 210 to be used by other devices, the digital twin sync process 222 may send the digital twin 210 or updates thereto to such other devices as the user changes the digital twin 210. Similarly, where the digital twin application device 200 uses a digital twin 210 created or modified by another device, the digital twin sync process 222 may request or otherwise receive the digital twin 210 or updates thereto from the other devices via the communication interface 220, and commit such received data to the database 212 for use by the other components of the digital twin application device 200. In some embodiments, both of these scenarios simultaneously exist as multiple devices collaborate on creating, modifying, and using the digital twin across various applications. As such, the digital twin sync process 222 (and similar processes running on such other devices) may be responsible for ensuring that each device participating in such collaboration maintains a current copy of the digital twin, as presently modified by all other such devices. In various embodiments, this synchronization is accomplished via a pub/sub approach, wherein the digital twin sync process 222 subscribes to updates to the digital twin 222 and publishes its own updates to be received by similarly-subscribed devices. Such a pub/sub approach may be supported by a centralized process, such as a process running on a central server or central cloud instance.

To enable user interaction with the digital twin, the digital twin application device 200 includes a user interface 230. For example, the user interface 230 may include a display, a touchscreen, a keyboard, a mouse, or any device capable of performing input or output functions for a user. In some embodiments, the user interface 230 may instead or additionally allow a user to use another device for such input or output functions, such as connecting a separate tablet, mobile phone, or other device for interacting with the digital twin application device 200. In some embodiments, the user interface 230 includes a web server that serves interfaces to a remote user's personal device (e.g., via the communications interface). Thus, in some embodiments, the applications provided by the digital twin application device 200 may be provided as a web-based software-as-a-service (SaaS) offering.

The user interface 230 may rely on multiple additional components for constructing one or more graphical user interfaces for interacting with the digital twin 210. A scene manager 232 may store definitions of the various interface scenes that may be offered to the user. As used herein, an interface scene will be understood to encompass a collection of panels, tools, and other GUI elements for providing a user with a particular application (or set of applications). For example, four interface scenes may be defined, respectively for a building design application, a site analysis application, a simulation application, and a live building analysis application. It will be understood that various customizations and alternate views may be provided to a particular interface scene without constituting an entirely new interface scene. For example, panels may be rearranged, tools may be swapped in and out, and information displayed may change during operation without fundamentally changing the overall application provided to the user via that interface scene.

The UI tool library 234 stores definitions of the various tools that may be made available to the user via the user interface 230 and the various interface scenes (e.g., by way of a selectable interface button). These tool definitions in the UI tool library 234 may include software defining manners of interaction that add to, remove from, or modify aspects of the digital twin. As such, tools may include a user-facing component that enables interaction with aspects of the user interface scene, and a digital twin-facing component that captures the context of the user's interactions, and instructs the digital twin modifier 252 or generative engine 254 to make appropriate modifications to the digital twin 210. For example, a tool may be included in the UI tool library 234 that enables the user to create a zone. On the UI side, the tool enables the user to draw a square (or other shape) representing a new zone in a UI workspace. The tool then captures the dimensions of the zone and its position relative to the existing architecture, and passes this context to the digital twin modifier 252, so that a new zone can be added to the digital twin 210 with the appropriate position and dimensions.

A component library 236 stores definitions of various digital objects that may be made available to the user via the user interface 230 and the various interface scenes (e.g., by way of a selection of objects to drag-and-drop into a workspace). These digital objects may represent various real-world items such as devices (e.g., sensors, lighting, ventilation, user inputs, user indicators), landscaping, and other elements. The digital objects may include two different aspects: an avatar that will be used to graphically represent the digital object in the interface scene and an underlying digital twin that describes the digital object at an ontological or functional level. When the user indicates that a digital twin should be added to the workspace, the component library provides that object's digital twin to the digital twin modifier 252 so that it may be added to the digital twin 210.

A view manager 238 provides the user with controls for changing the view of the building rendering. For example, the view manager 238 may provide one or more interface controls to the user via the user interface to rotate, pan, or zoom the view of a rendered building; toggle between two-dimensional and three-dimensional renderings; or change which portions (e.g., floors) of the building are shown. In some embodiments, the view manager may also provide a selection of canned views from which the user may choose to automatically set the view to a particular state. The user's interactions with these controls are captured by the view manager 238 and passed on to the virtual cameras 242 and the renderers 240, to inform the operation thereof.

The renderers 240 include a collection of libraries for generating the object representations that will be displayed via the user interface 230. In particular, where a current interface scene is specified by the scene manager 232 as including the output of a particular renderer 240, the user interface 230 may activate or otherwise retrieve image data from that renderer for display at the appropriate location on the screen.

Some renderers 240 may render the digital twin (or a portion thereof) in visual form. For example, a building renderer may translate the digital twin 210 into a visual depiction of one or more floors of the building it represents. The manner in which this is performed may be driven by the user via settings passed to the building renderer via the view manager. For example, depending on the user input, the building renderer may generate a two-dimensional plan view of floors 2, 3, and 4; a three-dimensional isometric view of floor 1 from the southwest corner; or a rendering of the exterior of the entire building.

Some renderers 240 may maintain their own data for rendering visualizations. For example, in some embodiments, the digital twin 210 may not store sufficient information to drive a rendering of the site of a building. For example, rather than storing map, terrain, and architectures of surrounding buildings in the digital twin 210, a site renderer may obtain this information based on the specified location for the building. In such embodiments, the site renderer may obtain this information via the communication interface 220, generate intermediate description of the surrounding environment (e.g., descriptions of the shapes of other buildings in the vicinity of the subject building), and store this for later user (e.g., in the database 212, separate from the digital twin). Then, when the user interface 230 calls on the site renderer to provide a site rendering, the site renderer uses this intermediate information along with the view preferences provided by the view manager, to render a visualization of the site and surrounding context. In other embodiments where the digital twin 210 does store sufficient information for rendering the site (or where other digital twins are available to the digital twin application device 200 with such information), the site renderer may render the site visualization based on the digital twin in a manner similar to the building renderer 240.

Some renderers 240 may produce visualizations based on information stored in the digital twin (as opposed to rendering the digital twin itself). For example, the digital twin 210 may store a temperature value associated with each zone. An overlay renderer may produce an overlay that displays the relevant temperature value over each zone rendered by the building renderer. Similarly, some renderers 240 may produce visualizations based on information provided by other components. For example, an application tool 260 may produce an interpolated gradient of temperature values across the zones and the overlay renderer may produce an overlay with a corresponding color-based gradient across the floors of each zone rendered by the building renderer.

The collaboration between virtual camera 242 and renderers 240 is fundamental in crafting the images destined for the user interface 230. Serving as a digital counterpart to a physical camera, the virtual camera defines critical attributes such as position, orientation, and field of view. It essentially becomes the “eye” through which the scene is observed, setting the stage for rendering by one or more renderers. The virtual camera assumes the role of determining the viewpoint and perspective for rendering, dictating which portion of the three-dimensional scene enters the frame. It also handles the selection of projection type, which can encompass perspectives, orthographics, or a fusion of both. Moreover, the virtual camera applies the appropriate projection matrix, effectively transforming the three-dimensional environment into a two-dimensional plane. Following this projection onto the two-dimensional plane, the renderer 240 takes over, rendering the flattened scene. In certain implementations, the virtual camera provides a transformation matrix used by the renderer 240 to accurately generate the final two-dimensional image.

As noted above, while various tools in the UI tool library 234 provide a user experience of interacting directly with the various renderings shown in the interface scene, these tools actually provide a means to manipulate the digital twin 210. These changes are then picked up by the renderers 240 and virtual camera 242 for display. To enable these changes to the digital twin, a digital twin modifier 252 provides a library for use by the UI tool library 234, user interface 230, component library 236 or other components of the digital twin application device 200. The digital twin modifier 252 may be capable of various modifications such as adding new nodes to the digital twin; removing nodes from the digital twin; modifying properties of nodes; adding, changing, or removing connections between nodes; or adding, modifying, or removing sets of nodes (e.g., as may be correlated to a digital object in the component library 236). In many instances, the user instructs the digital twin modifier 252 what changes to make to the digital twin 210 (via the user interface 230, UI tool library 234, or other component). For example, a tool for adding a zone, when used by the user, directly instructs the digital twin modifier to add a zone node and wall nodes surrounding it to the digital twin. As another example, where the user interface 230 provides a slider element for modifying an R-value of a wall, the user interface 230 will directly instruct the digital twin to find the node associated with the selected wall and change the R-value thereof.

In some cases, one or more contextual, constraint-based, or otherwise intelligent decisions are to be made in response to user input to determine how to modify the digital twin 210. These more complex modifications to the digital twin 210 may be handled by the generative engine 254. For example, when a new zone is drawn, the walls surrounding it may have difference characteristics depending on whether they should be interior or exterior walls. This decision, in turn, is informed by the context of the new zone in relation to other zones and walls. If the wall will be adjacent another zone, it should be interior; if not, it should be exterior. In this case, the generative engine 254 may be configured to recognize specific contexts and interpret them according to, e.g., a rule set to product the appropriate modifications to the digital twin 210.

As another example, in some embodiments, a tool may be provided to the user for generating structure or other object based on some constraint or other setting. For example, rather than using default or typical roof construction, the user may specify that the roof should be dome shaped. Then, when adding a zone to the digital twin, the generative engine may generate appropriate wall constructions and geometries, and any other needed supports, to provide a structurally-sound building. To provide this advanced functionality, the generative engine 254 may include libraries implementing various generative artificial intelligence techniques. For example, the generative engine 254 may add new nodes to the digital twin, create a cost function representing the desired constraints and certain tunable parameters relevant to fulfilling those constraints, and perform gradient descent to tune the parameters of the new nodes to provide a constraint (or other preference) solving solution.

Various interface scenes may provide access to additional application tools 260 beyond means for modifying the digital twin and displaying the results. As shown, some possible application tools include one or more analytics tools or simulators 264. The analytics tools 262 may provide advanced visualizations for showing the information captured in the digital twin 262. As in an earlier mentioned example, an analytics tool 262 may interpolate temperatures across the entire footprint of a floorplan, so as to enable an overlay renderer (not shown) to provide an enhanced view of the temperature of the building compared to the point temperatures that may be stored in each node of the digital twin 210. In some embodiments, these analytics and associated overlay may be updated in real time. To realize such functionality, a separate building controller (not shown) may continually or periodically gather temperature data from various sensors deployed in the building. These updates to that building controller's digital twin may then be synchronized to the digital twin 210 (through operation of the digital twin sync process 222), which then drives updates to the analytics tool.

As another example, an analytics tool 262 may extract entity or object locations from the digital twin 210, so that an overlay renderer (not shown) can then render a live view of the movement of those entities or objects through the building. For example, where the building is a warehouse, inventory items may be provided with RFID tags and an RFID tracking system may continually update its version of the building digital twin with inventory locations. Then, as this digital twin is continually or periodically synced to the local digital twin 210, the object tracking analytics tool 262 may extract this information from the digital twin 262 to be rendered. In this way, the digital twin application device 200 may realize aspects of a live, operational BIM.

The application tools 260 may also include one or more simulators 264. As opposed to the analytics tools 262 which focus on providing informative visualizations of the building as it is, the simulator tools 264 may focus on predicting future states of the building or predicting current states of the building that are not otherwise captured in the digital twin 210. For example, a shadow simulator 264 may use the object models used by the site renderer to simulate shadows and sub exposure on the building rendering. This simulation information may be provided to the renderers 240 for rendering visualizations of this shadow coverage. As another example, an operation simulator 264 may simulate operations of the digital twin 210 into the future and provide information for the user interface 230 to display graphs of the simulated information. As one example, the operation simulator 264 may simulate the temperature of each zone of the digital twin 210 for 7 days into the future. The associated interface scene may then drive the user interface to construct and display a line graph from this data so that the user can view and interact with the results. Various additional application tools 260, methods for integrating their results into the user interface 230, and methods for enabling them to interact with the digital twin 210 will be apparent.

FIG. 3 illustrates an example digital twin 300 for construction by or use in various embodiments. The digital twin 300 may correspond, for example, to digital twin 120a or digital twin 210. As shown, the digital twin 300 includes a number of nodes 310, 311, 312, 313, 314, 315, 316, 320, 321, 322, 323 connected to each other via edges. As such, the digital twin 300 may be arranged as a graph, such as a neural network. In various alternative embodiments, other arrangements may be used. Further, while the digital twin 300 may reside in storage as a graph type data structure, it will be understood that various alternative data structures may be used for the storage of a digital twin 300 as described herein. The nodes 310-323 may correspond to various aspects of a building structure such as zones, walls, and doors. The edges between the nodes 310-323 may, then, represent between the aspects represented by the nodes 310-323 such as, for example, adjacency for the purposes of heat transfer.

As shown, the digital twin 300 includes two nodes 310, 320 representing zones. A first zone node 310 is connected to four exterior wall nodes 311, 312, 313, 315; two door nodes 314, 316; and an interior wall node 317. A second zone node 320 is connected to three exterior wall nodes 321, 322, 323; a door node 316; and an interior wall node 317. The interior wall node 317 and door node 316 are connected to both zone nodes 310, 320, indicating that the corresponding structures divide the two zones. This digital twin 300 may thus correspond to a two-room structure.

It will be apparent that the example digital twin 300 may be, in some respects, a simplification. For example, the digital twin 300 may include additional nodes representing other aspects such as additional zones, windows, ceilings, foundations, roofs, or external forces such as the weather or a forecast thereof. It will also be apparent that in various embodiments the digital twin 300 may encompass alternative or additional systems such as controllable systems of equipment (e.g., HVAC systems).

According to various embodiments, the digital twin 300 is a heterogenous neural network. Typical neural networks are formed of multiple layers of neurons interconnected to each other, each starting with the same activation function. Through training, each neuron's activation function is weighted with learned coefficients such that, in concert, the neurons cooperate to perform a function. The example digital twin 300, on the other hand, may include a set of activation functions (shown as solid arrows) that are, even before any training or learning, differentiated from each other, i.e., heterogenous. In various embodiments, the activation functions may be assigned to the nodes 310-323 based on domain knowledge related to the system being modeled. For example, the activation functions may include appropriate heat transfer functions for simulating the propagation of heat through a physical environment (such as function describing the radiation of heat from or through a wall of particular material and dimensions to a zone of particular dimensions). As another example, activation functions may include functions for modeling the operation of an HVAC system at a mathematical level (e.g., modeling the flow of fluid through a hydronic heating system and the fluid's gathering and subsequent dissipation of heat energy). Such functions may be referred to as “behaviors” assigned to the nodes 310-323. In some embodiments, each of the activation functions may in fact include multiple separate functions; such an implementation may be useful when more than one aspect of a system may be modeled from node-to-node. For example, each of the activation functions may include a first activation function for modeling heat propagation and a second activation function for modeling humidity propagation. In some embodiments, these diverse activation functions along a single edge may be defined in opposite directions. For example, a heat propagation function may be defined from node 310 to node 311, while a humidity propagation function may be defined from node 311 to node 310. In some embodiments, the diversity of activation functions may differ from edge to edge. For example, one activation function may include only a heat propagation function, another activation function may include only a humidity propagation function, and yet another activation function may include both a heat propagation function and a humidity propagation function.

According to various embodiments, the digital twin 300 is an omnidirectional neural network. Typical neural networks are unidirectional-they include an input layer of neurons that activate one or more hidden layers of neurons, which then activate an output layer of neurons. In use, typical neural networks use a feed-forward algorithm where information only flows from input to output, and not in any other direction. Even in deep neural networks, where other paths including cycles may be used (as in a recurrent neural network), the paths through the neural network are defined and limited. The example digital twin 300, on the other hand, may include activation functions along both directions of each edge: the previously discussed “forward” activation functions (shown as solid arrows) as well as a set of “backward” activation functions (shown as dashed arrows).

In some embodiments, at least some of the backward activation functions may be defined in the same way as described for the forward activation functions-based on domain knowledge. For example, while physics-based functions can be used to model heat transfer from a surface (e.g., a wall) to a fluid volume (e.g., an HVAC zone), similar physics-based functions may be used to model heat transfer from the fluid volume to the surface. In some embodiments, some or all of the backward activation functions are derived using automatic differentiation techniques. Specifically, according to some embodiments, reverse mode automatic differentiation is used to compute the partial derivative of a forward activation function in the reverse direction. This partial derivative may then be used to traverse the graph in the opposite direction of that forward activation function. Thus, for example, while the forward activation function from node 311 to node 310 may be defined based on domain knowledge and allow traversal (e.g., state propagation as part of a simulation) from node 311 to node 310 in linear space, the reverse activation function may be defined as a partial derivative computed from that forward activation function and may allow traversal from node 310 to 311 in the derivative space. In this manner, traversal from any one node to any other node is enabled-for example, the graph may be traversed (e.g. state may be propagated) from node 312 to node 313, first through a forward activation function, through node 310, then through a backward activation function. By forming the digital twin as an omnidirectional neural network, its utility is greatly expanded; rather than being tuned for one particular task, it can be traversed in any direction to simulate different system behaviors of interest and may be “asked” many different questions.

According to various embodiments, the digital twin is an ontologically labeled neural network. In typical neural networks, individual neurons do not represent anything in particular; they simply form the mathematical sequence of functions that will be used (after training) to answer a particular question. Further, while in deep neural networks, neurons are grouped together to provide higher functionality (e.g. recurrent neural networks and convolutional neural networks), these groupings do not represent anything other than the specific functions they perform; i.e., they remain simply a sequence of operations to be performed.

The example digital twin 300, on the other hand, may ascribe meaning to each of the nodes 310-323 and edges therebetween by way of an ontology. For example, the ontology may define each of the concepts relevant to a particular system being modeled by the digital twin 300 such that each node or connection can be labeled according to its meaning, purpose, or role in the system. In some embodiments, the ontology may be specific to the application (e.g., including specific entries for each of the various HVAC equipment, sensors, and building structures to be modeled), while in others, the ontology may be generalized in some respects. For example, rather than defining specific equipment, the ontology may define generalized “actors” (e.g., the ontology may define producer, consumer, transformer, and other actors for ascribing to nodes) that operate on “quanta” (e.g., the ontology may define fluid, thermal, mechanical, and other quanta for propagation through the model) passing through the system. Additional aspects of the ontology may allow for definition of behaviors and properties for the actors and quanta that serve to account for the relevant specifics of the object or entity being modeled. For example, through the assignment of behaviors and properties, the functional difference between one “transport” actor and another “transport” actor can be captured.

The above techniques, alone or in combination, may enable a fully-featured and robust digital twin 300, suitable for many purposes including system simulation and control path finding. The digital twin 300 may be computable and trainable like a neural network, queryable like a database, introspectable like a semantic graph, and callable like an API.

As described above, the digital twin 300 may be traversed in any direction by application of activation functions along each edge. Thus, just like a typical feedforward neural network, information can be propagated from input node(s) to output node(s). The difference is that the input and output nodes may be specifically selected on the digital twin 300 based on the question being asked, and may differ from question to question. In some embodiments, the computation may occur iteratively over a sequence of timesteps to simulate over a period of time. For example, the digital twin 300 and activation functions may be set at a particular timestep (e.g., 1 minute), such that each propagation of state simulates the changes that occur over that period of time. Thus, to simulate longer period of time or point in time further in the future (e.g., one minute), the same computation may be performed until a number of timesteps equaling the period of time have been simulated (e.g., 60 one second time steps to simulate a full minute). The relevant state over time may be captured after each iteration to produce a value curve (e.g., the predicted temperature curve at node 310 over the course of a minute) or a single value may be read after the iteration is complete (e.g., the predicted temperature at node 310 after a minute has passed). The digital twin 300 may also be inferenceable by, for example, attaching additional nodes at particular locations such that they obtain information during computation that can then be read as output (or as an intermediate value as described below).

While the forward activation functions may be initially set based on domain knowledge, in some embodiments training data along with a training algorithm may be used to further tune the forward activation functions or the backward activation functions to better model the real world systems represented (e.g., to account for unanticipated deviations from the plans such as gaps in venting or variance in equipment efficiency) or adapt to changes in the real world system over time (e.g., to account for equipment degradation, replacement of equipment, remodeling, opening a window, etc.).

Training may occur before active deployment of the digital twin 300 (e.g., in a lab setting based on a generic training data set) or as a learning process when the digital twin 300 has been deployed for the system it will model. To create training data for active-deployment learning, a controller device (not shown) may observe the data made available from the real-world system being modeled (e.g., as may be provided by a sensor system deployed in the environment 110) and log this information as a ground truth for use in training examples. To train the digital twin 300, that controller may use any of various optimization or supervised learning techniques, such as a gradient descent algorithm that tunes coefficients associated with the forward activation functions or the backward activation functions. The training may occur from time to time, on a scheduled basis, after gathering of a set of new training data of a particular size, in response to determining that one or more nodes or the entire system is not performing adequately (e.g., an error associated with one or more nodes 310-323 passed a threshold or passes that threshold for a particular duration of time), in response to manual request from a user, or based on any other trigger. In this way, the digital twin 300 may be adapted to better adapt its operation to the real world operation of the systems it models, both initially and over the lifetime of its deployment, by tacking itself to the observed operation of those systems.

The digital twin 300 may be introspectable. That is, the state, behaviors, and properties of the 310-323 may be read by another program or a user. This functionality is facilitated by association of each node 310-323 to an aspect of the system being modeled. Unlike typical neural networks where, due to the fact that neurons don't represent anything particularly the internal values are largely meaningless (or perhaps exceedingly difficult or impossible to ascribe human meaning), the internal values of the nodes 310-323 can easily be interpreted. If an internal “temperature” property is read from node 310, it can be interpreted as the anticipated temperature of the system aspect associated with that node 310.

Through attachment of a semantic ontology, as described above, the introspectability can be extended to make the digital twin 300 queryable. That is, ontology can be used as a query language usable to specify what information is desired to be read from the digital twin 300. For example, a query may be constructed to “read all temperatures from zones having a volume larger than 200 square feet and an occupancy of at least 1.” A process for querying the digital twin 300 may then be able to locate all nodes 310-323 representing zones that have properties matching the volume and occupancy criteria, and then read out the temperature properties of each. The digital twin 300 may then additionally be callable like an API through such processes. With the ability to query and inference, canned transactions can be generated and made available to other processes that aren't designed to be familiar with the inner workings of the digital twin 300. For example, an “average zone temperature” API function could be defined and made available for other elements of the controller or even external devices to make use of. In some embodiments, further transformation of the data could be baked into such canned functions. For example, in some embodiments, the digital twin 300 itself may not itself keep track of a “comfort” value, which may be defined using various approaches such as the Fanger thermal comfort model. Instead, e.g., a “zone comfort” API function may be defined that extracts the relevant properties (such as temperature and humidity) from a specified zone node, computes the comfort according to the desired equation, and provides the response to the calling process or entity.

It will be appreciated that the digital twin 300 is merely an example of a possible embodiment and that many variations may be employed. In some embodiments, the number and arrangements of the nodes 310-323 and edges therebetween may be different, either based on the controller implementation or based on the system being modeled by each deployment of the controller. For example, a controller deployed in one building may have a digital twin 300 organized one way to reflect that building and its systems while a controller deployed in a different building may have a digital twin 300 organized in an entirely different way because the building and its systems are different from the first building and therefore dictate a different model. Further, various embodiments of the techniques described herein may use alternative types of digital twins. For example, in some embodiments, the digital twin 300 may not be organized as a neural network and may, instead, be arranged as another type of model for one or more components of the environment 110a. In some such embodiments, the digital twin 300 may be a database or other data structure that simply stores descriptions of the system aspects, environmental features, or devices being modeled, such that other software has access to data representative of the real world objects and entities, or their respective arrangements, as the software performs its function.

FIG. 4 at 400 illustrates an ontology graph structured at different levels of abstraction. There are no existing standards that include information about the properties and behaviors of equipment, plus the relationships between entities, sufficient enough to, e.g., simulate them. The ontology described herein with ontology domains and objects can be used to describe a digital twin, and uses, in part, a graph language. The ontology is designed from the ground up around the idea that objects should be modeled at a fundamental level using a small set of modular and largely isomorphic concepts. Among other aspects, this removes the focus and attention from “what is this thing called?” to focusing on “how do things work quantitatively?” Levels of abstraction are interconnected with relationships, allowing us to reveal phenomena like the butterfly effect, where a change at the behavioral level can lead to implications at the building and portfolio levels. Within the disclosed framework, we finally have a way to build digital twins that are much more than visual copies of their real-world counterparts. They mimic the same behavior and attributes down to the most basic entities. The domains do not always map directly onto this hierarchical level view, but rather are sometimes used throughout the different levels. The portfolio level 405 includes multiple buildings that have or will have digital twins associated with them.

The building level 410 generally describes a single building and roughly maps to the site domain, the people domain, the event domain, the environment domain and the building domain. The system level 415 describes entire systems within the building, such as HVAC systems, lighting systems, sound systems, and so on. This maps roughly onto the system domain. These systems 415 may be broken down into subsystems 420, which are quasi-independent sections of systems, and which roughly map onto the system domain too. The subsystems 420 can further be broken down into equipment 425, which maps onto the equipment domain. Within the equipment are behaviors 430 which describe how the equipment acts. These may be physics equations. For example, a pump's behaviors may be described in terms of flow rate, pressure, head power, and efficiency in terms of physics equations. These physics equations with constants and variables. Such constants and variables are described with reference to a flat graph 435, which describes the physics equations in terms of the values that will be used at a specific time in, for example, a simulation that is being run using a digital twin 120a.

A brief overview of a selection of current domains is now presented. The site domain 184a captures high-level geographic object types such as which buildings may occupy a given site. Some objects associated with the site domain are campus and site.

The people domain 182a relates to information associated with people who will be using a building. Users and organizations are the two primary object types in this domain. In deconstructing how users interact and engage with buildings (and the things inside them) as well as when they interact with them (at what point in the lifecycle), there are many different needs and personas. Users are related to organizations, sites, and other object types via different roles. Specifically, the people domain 182a includes the objects user, organization, device (IsPartOf user), and other housekeeping objects.

The asset domain 181a is related to users, organizations, and buildings in different ways. An asset might be the throughput of a warehouse, but it may be owned by some external organization. Oftentimes, assets have particular needs or environmental constraints (must be kept frozen, etc.). The asset domain has an asset object. This object is related to zone (an object in the building domain), adjacency (another object in the building domain), user (an object in the people domain), and so on.

The environmental domain 189a describes some aspects of the environment around a building. Buildings exist and operate in many different environments. From a system modeling perspective, it's crucial to know where a building is located, as this is used to understand the environmental conditions in which it operates. Some objects associated with the environmental domain are location, location property, and weather source.

The building domain 188a describes among other things, the physical construction and topology of a building, such that the building itself may be able to be modeled by a digital twin 120a. The building domain (shown, in part, with reference to FIG. 1A) includes floors, zones, surfaces, layers, all of which are characterized with different attributes and relationships. For example, the object zone's relationships includes objects in many different domains: assets, in the asset domain; equipment, in the equipment domain; floor, in the building domain, properties, in the property domain; surfaces in the system domain, etc.

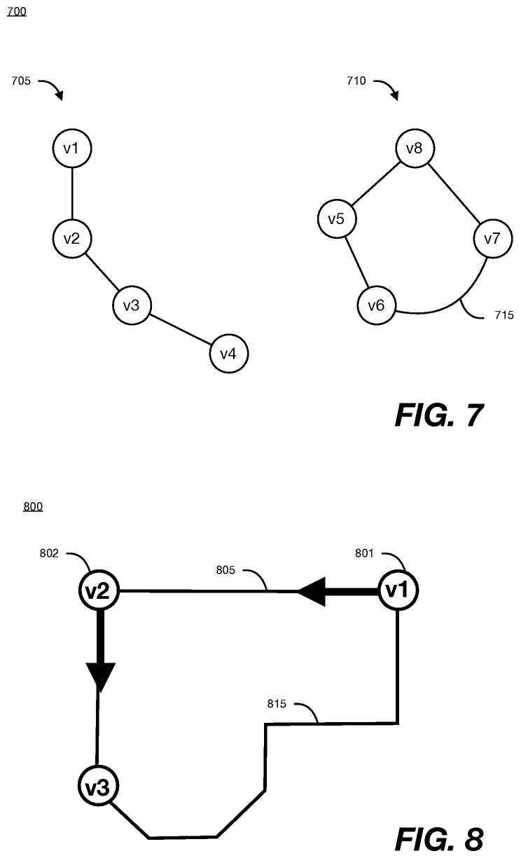

The geometry domain 185a describes a physical geometry of a building, within a building, of an object, etc. A building must be able to reconstruct the 3D landscape that it operates in. Equipment and assets need to be located at some point in space (a sensor on a wall, an air terminal in the ceiling). Shapes and vertices are the key object types in this domain, enabling 3D reconstruction of physical spaces and things. These are described in greater detail with reference to FIGS. 7 and 8.

The system domain 186a describes interconnected groups of equipment. From this interconnectedness and the designated roles of the equipment in the system, subsystems, loops, and operational constraints for the system and its contained equipment can be deduced. The system objects include system, subsystem set, and subsystem.

The equipment domain 187a, shown in part with reference to FIG. 1A, includes as objects, equipment, equipment components, connection nodes, manufacturer, model. A component—an important building block in the ontology-is an object that can explain its identity. The identity is determined at least in part by the components' specified actor and quanta type on which it acts, associated with their own domains. System topology may be determined by the interconnectedness of components, both within and across equipment boundaries.

The quanta domain 191a describes energy flows between objects. This domain includes quanta, which are defined as packets of substance exchanged between and operated on by components. They are often thought of as the things that capture state information. Media is another objection the quanta domain, which further specifies the type of quanta. For example, the quanta object may be “liquid,” while the media may be “water.”

The property domain 188a describes values and behaviors that are used to determine behavior within a digital twin 120a. The property domain includes as objects: behavior, equation, property, unit preference. Property objects may be assembled into equation objects which may define behavior objects. Behavior objects may sometimes be defined using property objects. A property is a generic numeric quantity that can be associated with many different types of objects. Similar to a variable in a programming language, a property can be computed (via a series of operators, literals, or other properties) or can have a literal value.

The time series domain 159a describes time series that may be used to characterize system behavior. Autonomous systems require the ability to understand and learn from the past and understand what the future may hold. Historical or predicted values of properties and events are captured in this domain.

The event domain 158a describes event groupings. Autonomous systems in many environments often require decentralized orchestration and computing. Additionally, alerting based on observed data patterns and notifications of relevant parties for time-sensitive error resolution is captured in this domain. The objects here include event class, event history, event relation, and event type.

The binding domain 190a defines category of object types that can be generically associated with other objects for the purposes of conveying metadata. This metadata may be a tag, an image, an animation, etc. The objects that are defined here include animation, image, property tag router, and tag.

The domains interact in interesting and unexpected ways. To explore these ideas, a brief overview of the building ontology domain and related domains will be discussed in context of construction of a portion of a building. A component of the disclosed building geometry representation and a building domain object is a zone 157a, which represents a portion of the building dedicated to a purpose, in broad terms. Such a purpose may be, for example, recording the state (such as temperature, humidity, etc.) within the zone. The ontology described herein define spaces that exist entirely in their own right, without knowing the location or context in a building. Rather than spaces being derived from walls, surfaces, or vertices, the shape of the space is defined first, and in coordination with other spaces in the building, the walls, surfaces, and adjacencies are derived from the intersection of spaces. Spaces are usually defined by the areas encapsulated by the constructed (physical) walls of the building, such as a typical office. However, building spaces don't always break up according to physical boundaries and often require logical boundaries. These logical boundaries may be characterized as “air boundaries”.

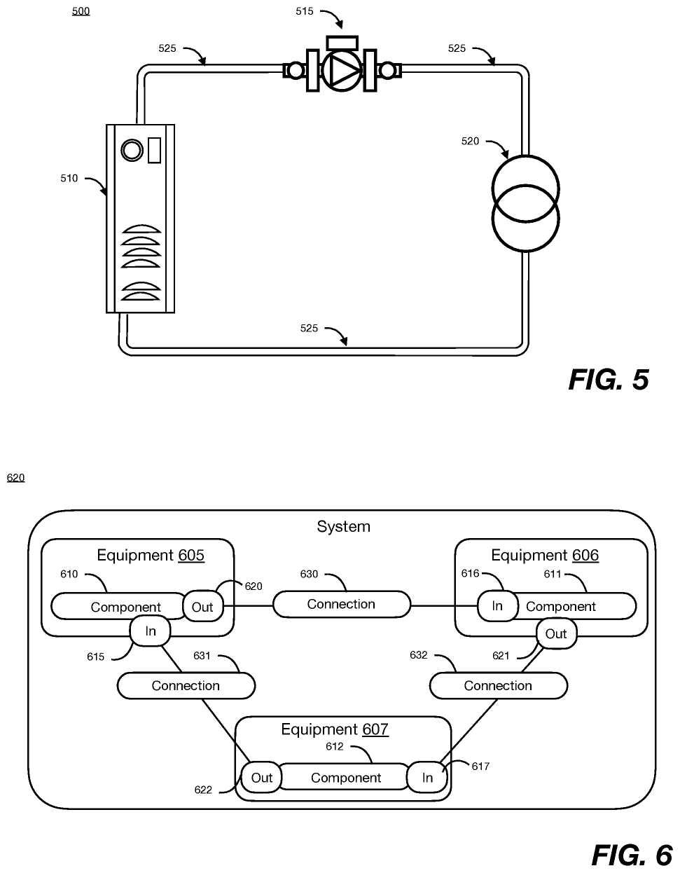

FIG. 5 illustrates some basic principles used by the disclosed ontology which may be used to describe digital twins as described herein and which may be viewed by implementations described herein. When engineers design and build systems, either for an HVAC application, a scientific application, etc., they are placed into the system with intent. As an example, a simple hydronic loop 500 has a boiler 510, a pump 515, a load 520, and pipes 525 connecting them. The idea of the disclosed ontology is designed to answer the questions of “what is this system designed to do?” and “what are each of the things in the system supposed to accomplish?” In this example, the goal of the system is to maintain a thermal condition of the load 520; the boiler 510 is designed to provide thermal energy to the load; the pump 515 is designed to overcome pressure losses in the system to transport the thermal energy to the load; and the pipes 525 provide pathways for the media carrying the thermal energy to reach the load 520. If any of those objects were missing from the system, it could be considered incomplete and non-functional as to its design intent. Understanding the intended role of something in a system is done by actor types. The actor type is a an attribute of an equipment component 163b, which is an object in the domain “equipment” 161b. The actor type characterizes the intended role of a thing in a system. With continuing reference to FIG. 5, the pump 515 is characterized as a transport actor, since its intended role in the system is to move (transport) liquid throughout the system. The liquid is a type of quanta, as defined in the quanta ontology 191a. Quanta are packets of substance that are exchanged by, e.g., equipment (as described in the equipment ontology 140b). Quanta themselves are mostly two objects; a pairing of a specific quanta type and a media. With reference to FIG. 3, the media being circulated through the pipes might be water, and the quanta type would be a liquid; this would be a liquid quanta with a water media. Other quanta/media groups may be gas quanta and air media; wired protocol quanta and BACnet media, etc. These quanta carry state around and are acted upon by components within the system. As the quanta moves around the system above, its state properties are manipulated (or transformed) by the different equipment components 163b. The transform that acts on the properties of a quanta is a behavior object (found, as discussed above, in the “property” quanta.

FIG. 6 at 600 describes some aspects of equipment 605, 606, 607, with relationship to the equipment component 610, 611, 612—one of the building block of systems defined herein. The equipment component 163b is an object within the equipment domain 150b. The identity of a component 610, 611, 612 may be based on the quanta type (from the quanta domain) that flows through it, behaviors and properties associated with the property domain 188a through the geometry 185a associated with a piece of equipment 142a, or some combination of the above. The physical attributes of a component may be considered properties, as discussed, which can be either literal values or computed via an equation. For example, the diameter of a pump impeller might be defined as a property (d) with a literal value (i.e. 4 inches). The circumference of the pump impeller may be defined as a property of the pump computed via an equation, e.g., π*d. Once the identity of the component is framed using the different objects within the ontology, incoming nodes 615, 616, 617 and outgoing nodes 620, 621, 622 that connect to a connection node 630, 631, 632 may be added to the component, which define the required quanta types. The connection nodes are objects of the equipment domain, and include as an attribute, a connection direction. Components 610, 611, 612 may then be “wired” together into equipment (e.g., 142a) through their equipment domain connection node properties and systems (e.g., 186a) through the equipment domain system relationship. Closed loops between the connections of components are used to infer systems, subsystems, and overall topology. The requirements placed on component connectivity and the nature of the described ontology enables components 610, 611, 612 within the equipment domain 142a to be reused across different equipment and system topologies.

In embodiments discussed herein, spaces are defined as existing entirely in their own right, without knowing the location or context in the space being represented. As such, they are part of the geometry domain. Rather than spaces being derived from walls, surfaces, or vertices, the shape of the space is defined first, and in coordination with other spaces in the building, the walls, surfaces, and adjacencies are actually derived from the intersection of spaces. This is different than the usual definition of spaces as usually defined by the areas encapsulated by the constructed (physical) walls of the building, such as a typical office. However, building spaces don't always break up according to physical boundaries and often require logical boundaries. Logical boundaries may be conceptualized as “air boundaries”. To create these defined spaces, shapes are used as a basic geometric concept described in the geometry domain. A shape may be thought of as an ordered list of vertices that are connected together. The ordering is important, as it defines the path of traversal for the shape, enabling both convex and concave shapes. The vertices usually lie in a flat 2D plane, but may also be within a 3D geometry.

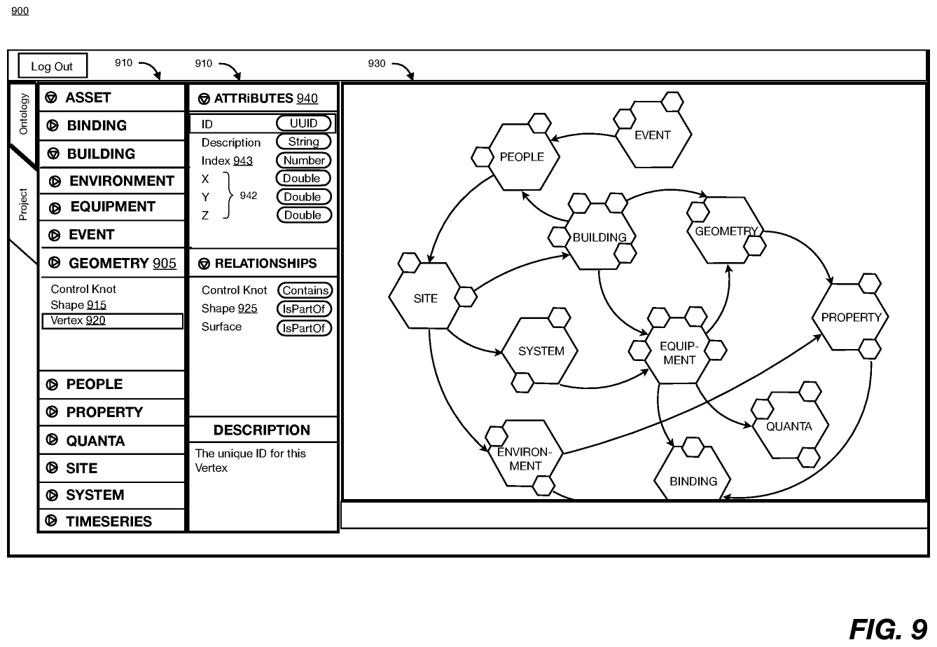

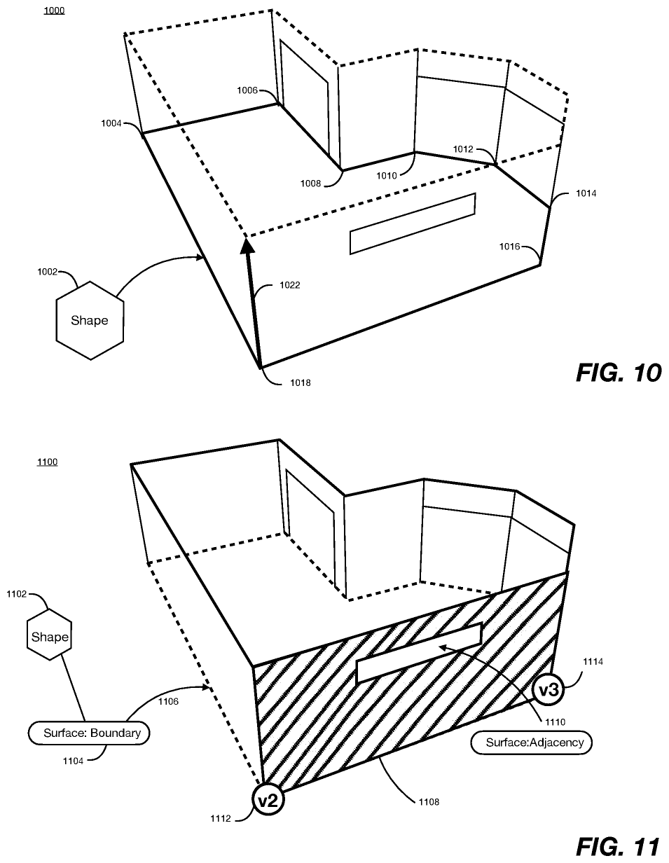

FIG. 7 illustrates examples of some shapes made of vertices 700 that may be used in embodiments described herein. Shapes are an object within the geometry domain that contains an ordered list of vertices, vertex being another object within the geometry domain. FIG. 9 illustrates an example viewing and exploring suite 900 that currently displays a geometry domain 905 open on the left panel. As can be seen, some of the objects in the geometry domain are shape 915 and vertex 920, with multiple vertices within a shape 925. “Shape” possesses an attribute indicating if the full shape is a closed loop 710 or open 705. An open shape will have start and end points 705, with v1 being the starting point and v4 being the end point, or vice-versa. In some embodiments, these shapes are similar to polygons, but are not necessarily composed entirely of straight line connections as shown between vertices v6 and v7, where there is a curve 715 connecting two vertices instead of a straight line. One advantage of this structure is that it conveys adjacency information and, in the closed case, has an inside/outside that can be inferred. Which segments are connected together is known. Whether vertices are in the shape can be queried. Shapes are used in a variety of ways throughout the embodiments described herein; a few examples include: 1) defining floor plans, 2) defining custom shaped apertures, and 3) defining sub-surface geometry.

FIG. 8 at 800 is an example of a shape that may be used to at least partially describe a floorplan. Here, vertex 1 801 represents the beginning of a wall around the loop. The length of the wall is determined by the distance to the next vertex, which is itself dependent on the locations of the two vertices, as stored within the geometry domain vertex object. These vertices are themselves stored in a geometry domain shape object, as described. A first wall 805 starts at vertex v1 801, and runs to vertex v2 802. A second wall starts at vertex v2 802 and runs to the next vertex v3, etc. As this shape is closed (as defined by a shape attribute), the loop 815 formed by the vertices encloses the boundary of the space, and may be referred to as the boundary shape. The boundary shape determines the floor plan of any particular zone. The exact shape of each wall, as well as the floor and ceiling is implicit in this model. The context of the wall within the boundary must be considered to understand its length. In some three-dimensional embodiments, the floor plan may be then extruded by a height to give the three-dimensional shape of the space, an example of which is found with reference to FIG. 10.

FIG. 9 illustrates an example cluster view of the ontology graph explorer 930 with the geometry domain 905 selected. A drawer has opened up 927 showing the objects that are associated with the geometry domain 905. They are control knot, shape 915, and vertex 920. The vertex object has been selected, opening the details browser 910. The details browser 910 displays the attributes 940 of the chosen geometry object-vertex 920. These attributes include an x, y and z axis 942, and an index. Using the index 943 and the three axes 942 allow a series of vertices 920 be turned into a shape 925.

FIG. 10 illustrates an example surface 1000 that has been turned into a 3D object. The closed shape 1002 includes the vertices 1004, 1006, 1008, 1010, 1012, 1014, 1016, and 1018. extruded in the z (or otherwise appropriate) axis attributes of the vertices 1022 that make up the shape. The shape includes an attribute “height” that determines the height of the z axis for the shape.

FIG. 11 illustrates example surfaces 1100 as defined by the ontology discussed herein. A surface may be thought of conceptually as a logical piece of construction in a space such as a wall, door, or window. Within the described ontology a surface is an object 156a in the building domain 152a. Among other relationships, surfaces contain shapes 915 and vertices 920 from the geometry domain 905, properties from the property domain, and zones 157a from the building domain 152a. Whereas shapes are concrete in the sense that they exist as they are being defined by their vertices which have an x, y, and z value, surfaces are more conceptual as they are a consequence of the geometry definition; e.g., they are created from existing shapes. Surface type is an attribute of the surface object (e.g., 156a). The surface type is a mechanism used to convey the purpose of a surface.

One type of surface is “boundary.” A shape 1102 has a relationship with surface of type boundary 1104. This shape 1102 with a surface of type boundary 1104 defines a room boundary 1106. The purpose of a boundary surface is to capture the shape of the space. A surface object (in the building domain) is related to a vertex object (in the geometry domain) contained by another surfaces' shape. That is, both surfaces share the same vertex. For example, the wall surface 1108 is related to the boundary surface 1106 of the instant space through the vertices v3 1112 and v3 1114, which are shared by the shape 1102 and the shape that represents the wall 1108. Surfaces may also be related via an adjacency object, also within the building domain. For example, window surface 1110 may have an adjacency object 1110 that indicates the wall surface 1108 may be used to indicate how fenestration (windows, doors, etc.) are related to a wall that encompasses the fenestration. Here, and adjacency object Other surface types are intended to convey characteristics of the surface, such as thermal characteristics, electrical characteristics, light characteristics, etc.

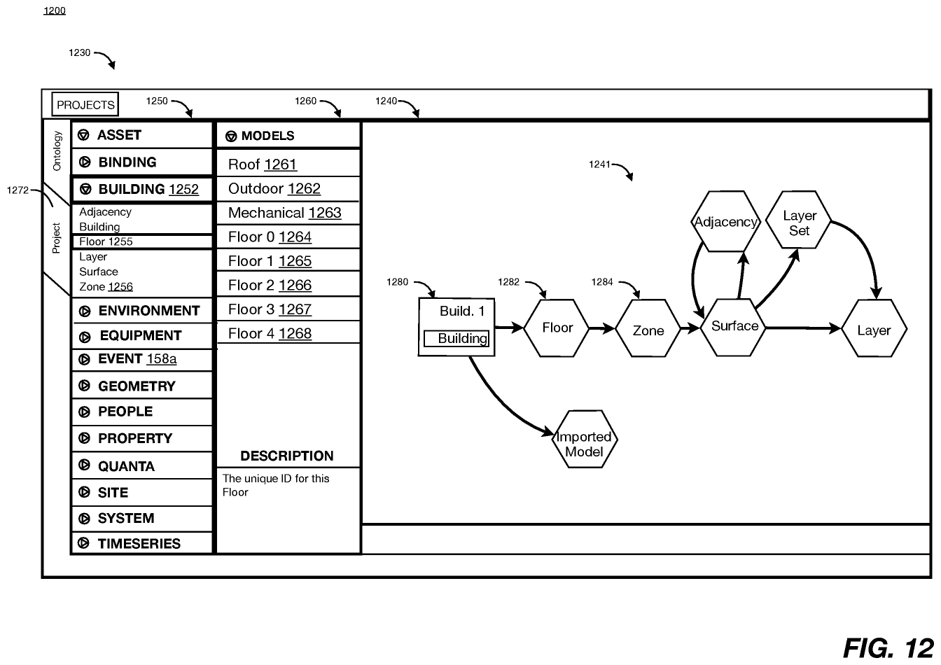

FIG. 12 depicts one embodiment of a graphical user interface 1200 of an instance graph view of an ontology 1230 of an already existing digital twin. This instance graph utilizes a hierarchical cluster to display the data in the main viewing area 1240. The schema 1241 of a specific domain (the building domain) is displayed showing the interrelations between the different objects that make up the building domain. Using this instance graph 1230, a user can explore the specific data within this section of the schema of the existing digital twin. In the depicted embodiment, to view an instance graph, with reference to FIG. 1A, select a tab, such as the “Project” tab 172a within an ontology view in the digital town application suite 130a. In some instances, when a specific domain has been selected within the ontology view, e.g., the “Building” domain 152a, and when the project tab 172a, 1272 is selected, a project view 1240 of the previously selected domain appears in the main panel—in this case, the building domain 1252. In some embodiments, the domains in the ontology are shown in the left-hand objects browser 1250. In some embodiments, the object browser is in a different location. Within the object browser 1250, selecting a domain allows a user to view the objects that make up the domain. In some embodiments, the different objects associated with the selected domain (e.g., the building domain) may be displayed in relation to the building domain. In this case, the objects appear underneath the building domain tag 1252. In a main window 1240, the project view—a schema (e.g. the specific underlying architectures) with ties to an instance graph for the selected domain 1241—may appear. This schema: instance graph combo may include some or all of the objects of the domain showing their relationships. For an embodiment of the building domain, the building object 1280 contains floor objects 1262, represented by an icon-in this case, a hexagon-which contains zone objects 1264 represented by an icon, and so forth. Different ontologies may have different domains, different objects, and different icons. In the instant case, the floor object 1255 displayed in the left-hand panel 1250 has been chosen. In such a case, the floor objects in the displayed building 1241 are shown in the details browser 1260. The current model 1230 has the following floor object instances: Roof 1261, Outdoor 1262, Mechanical 1263, and Floors 0 through 4 1264-1268.

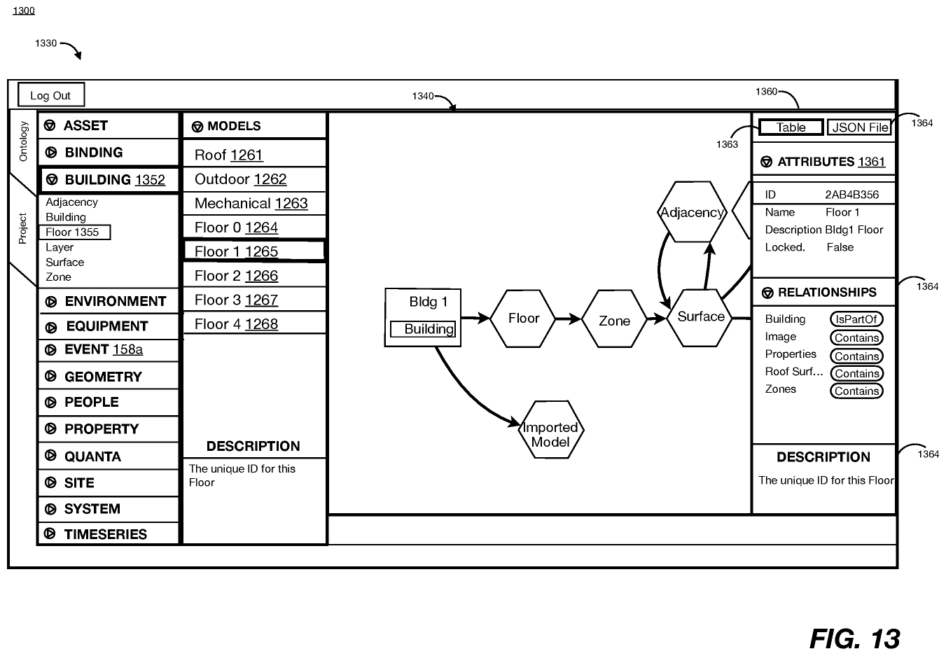

FIG. 13 depicts an embodiment of a graphical user interface 1300 for viewing an instance graph of an ontology with some of the underlying data displayed. This view allows viewing of both the schema and some of the data associated with this specific instance graph. In this embodiment, the building domain 1352 has been selected, and out of the drawer that opened up below it to display the objects associated with the domain, the floor object 1355 has been chosen. Data about the selected object (e.g., “floor”) now appears on a details browser 1360 (in this embodiment, on the right side of the page). These details include attributes 1361 of the specific instance of the chosen floor such as its ID, name, description, etc., relationships 1364 between the floor object and other objects, and, a description of the selected attribute, selected object, or other selected screen item.

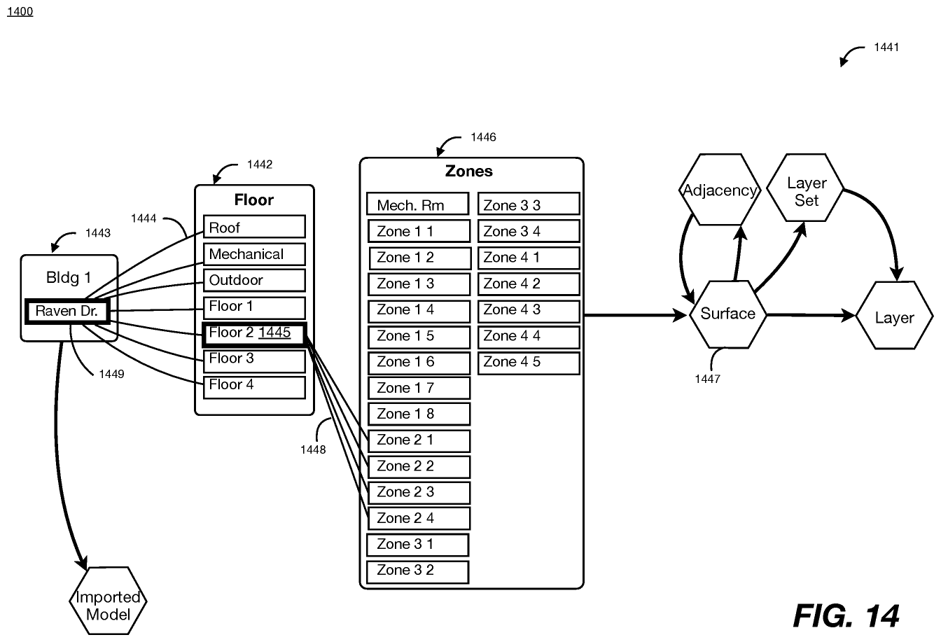

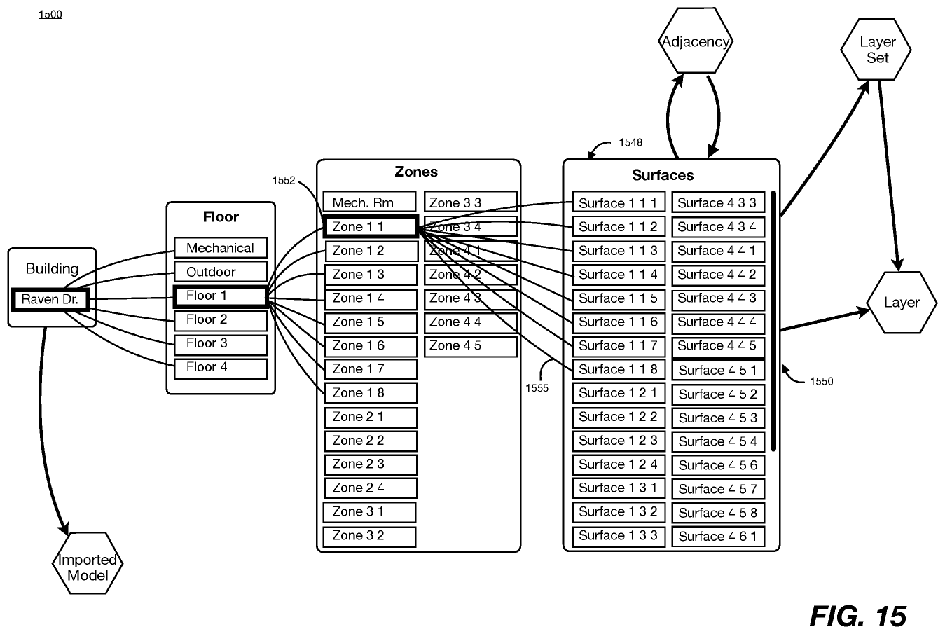

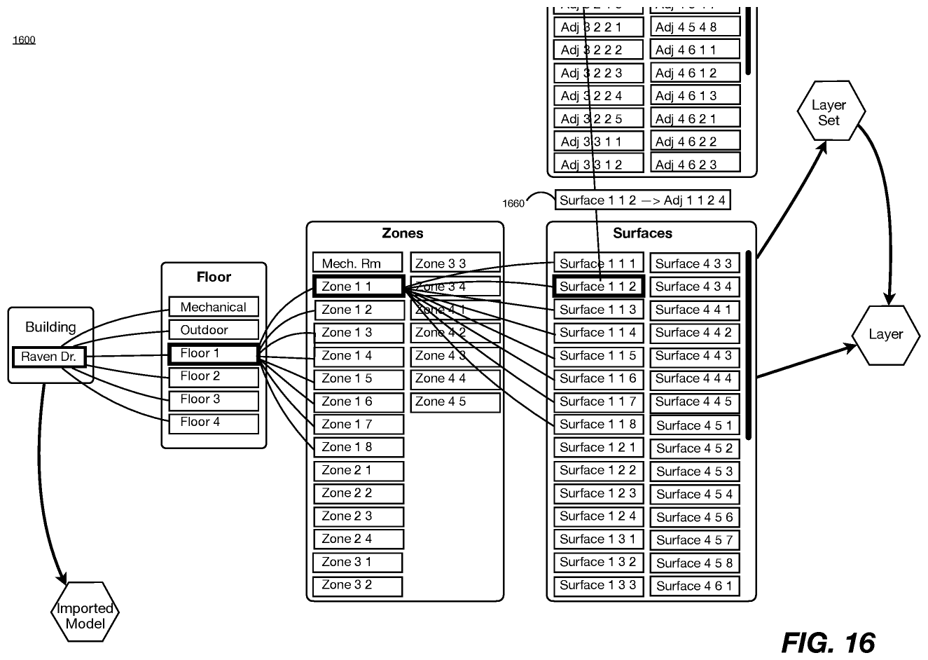

FIG. 14 depicts an embodiment of a portion of a user interface 1400 used to display data within an instance graph of an ontology, with some of its data displayed within a cluster hierarchy of the schema. In this FIGURE, and in FIGS. 15 and 16, the main panel, e.g., 1240, 1340 only is shown, without details browsers 1260, 1360 being shown. In an instance graph view 1441, selecting the cluster view of the schema of an object such as a floor 1282 (with reference to FIG. 12), opens up the object to display instances of that object floor 1442 within the current instance graph, e.g., Bldg 1 1443. Relationship lines 1444 run between a selected object and objects that are related to that object, displaying the links between the objects. For example, the building object Bldg 1 “Raven Dr.” is shown selected 1449. Selecting the floor icon, e.g., 1282, brings up a table 1442 with the data from the Bldg 1 digital twin instance graph. The connections between Bldg 1 and the floor data objects are shown as connected to seven floor objects, “Roof,” “Mechanical,” “Floor 1” . . . “Floor 4” by a series of lines 1444 indicating the connection. For clarity, in this and other views a single line is labeled to indicate all logically grouped lines. With reference to FIG. 12, selecting the floor object 1255 may expand the floor icon 1252 into the floor table 1442. When the “Zones” shape 1284 (with reference to FIG. 12) is selected (either from the main screen 1284 or the left-hand objects browser 1256, zones 1446 in the current instance graph (zones that have been defined with reference to Bldg 1 1443) are displayed. When a related object (e.g., Floor 2 1445) is selected, connection lines 1448 between the associated objects (e.g., floor 2 1445 and Zone 2 1, Zone 2 2, Zone 2 3, and Zone 2 4) and are displayed. This indicates that floor 2 1445 has four zones defined within it.

FIG. 15 depicts an embodiment of a portion of a user interface 1500 used to display an instance graph of an ontology when there are more instances than can fit in a window. Instance graphs may be larger than can easily be displayed on a user interface. In such cases, a method of viewing the instances within an objects is supplied. Here, the surfaces object 1548 has been expanded (by the user selecting a zone object 1552 in some fashion), exposing more surface instances than can reasonably be viewed altogether. In this embodiment, the surfaces instances have opened up into a window with a scroll bar to allow the window to be scrolled to see the various embodiments. The connection lines 1555 between the chosen zone 1552 and its connected surface are displayed. As the surface data instances scroll, the connection lines (e.g., 1555) will appear as the data instances appear in the window 1550 and will disappear as the data instances scroll out of view. In some embodiments, data instances are displayed in columns, which may be configurable columns of 20. In some instances, three columns of 20 may be displayed. In some embodiments, scrolling is enabled when there are more than 60 data instances to be displayed. In some embodiments, two columns of 20 are displayed. The number of data instances that may be displayed is dependent on the implementation.

FIG. 16 depicts an embodiment of a portion of a user interface 1600 used to display connection lines within an instance graph of an ontology. When a user using a user interface hovers over or otherwise selects a connection line, a label that includes the name of the “contains” object (e.g., surface 1 1 2) followed by the “is part of” object (e.g., Adj 1 1 2 4) may be displayed 1660. In some embodiments, the label may always be displayed.

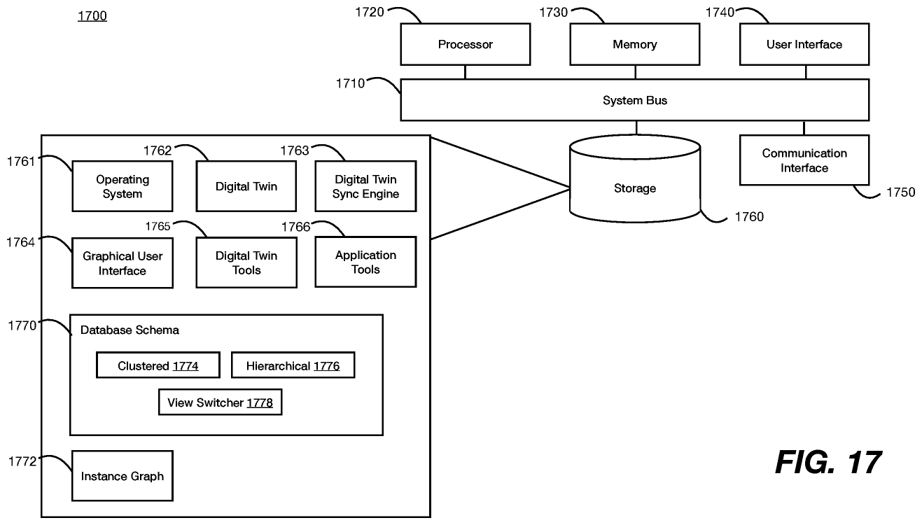

FIG. 17 illustrates an example hardware device 1700 for implementing a digital twin application device. The hardware device 1700 may describe the hardware architecture and some stored software of a device providing a digital twin viewing and exploring suite 130a or the digital twin application device 200. As shown, the device 1700 includes a processor 1720, memory 1730, user interface 1740, communication interface 1750, and storage 1760 interconnected via one or more system buses 1710. It will be understood that FIG. 17 constitutes, in some respects, an abstraction and that the actual organization of the components of the device 1700 may be more complex than illustrated.

The processor 1720 may be any hardware device capable of executing instructions stored in memory 1730 or storage 1760 or otherwise processing data. As such, the processor 1020 may include a microprocessor, field programmable gate array (FPGA), application-specific integrated circuit (ASIC), or other similar devices.

The memory 1730 may include various memories such as, for example L1, L2, or L3 cache or system memory. As such, the memory 1030 may include static random access memory (SRAM), dynamic RAM (DRAM), flash memory, read only memory (ROM), or other similar memory devices. It will be apparent that, in embodiments where the processor includes one or more ASICs (or other processing devices) that implement one or more of the functions described herein in hardware, the software described as corresponding to such functionality in other embodiments may be omitted.

The user interface 1740 may include one or more devices for enabling communication with a user such as an administrator. For example, the user interface 1740 may include a display, a mouse, a keyboard for receiving user commands, or a touchscreen. In some embodiments, the user interface 1040 may include a command line interface or graphical user interface that may be presented to a remote terminal via the communication interface 1750 (e.g., as a website served via a web server).

The communication interface 1750 may include one or more devices for enabling communication with other hardware devices. For example, the communication interface 1750 may include a network interface card (NIC) configured to communicate according to the Ethernet protocol. Additionally, the communication interface 1750 may implement a TCP/IP stack for communication according to the TCP/IP protocols. Various alternative or additional hardware or configurations for the communication interface 1750 will be apparent.

The storage 1760 may include one or more machine-readable storage media such as read-only memory (ROM), random-access memory (RAM), magnetic disk storage media, optical storage media, flash-memory devices, or similar storage media. In various embodiments, the storage 1760 may store instructions for execution by the processor 1720 or data upon with the processor 1720 may operate. For example, the storage 1760 may store a base operating system 1761 for controlling various basic operations of the hardware 1700.

The storage 1760 additionally includes a digital twin 1762, such as a digital twin according to any of the embodiments described herein. As such, in various embodiments, the digital twin 1062 includes a heterogeneous and omnidirectional neural network. A digital twin sync engine 1763 may communicate with other devices via the communication interface 1750 to maintain the local digital twin 1762 in a synchronized state with digital twins maintained by such other devices. Graphical user interface instructions 1064 may include instructions for rendering the various user interface elements for providing the user with access to various applications. As such, the GUI instructions 1764 may correspond to one or more of the scene manager 232, UI tool library 234, component library 236, view manager 238, user interface 230, or portions thereof. Digital twin tools 1765 may provide various functionality for modifying the digital twin 1762 and, as such, may correspond to the digital twin modifier 252 or generative engine 254. Application tools 1766 may include various libraries for performing functionality for interacting with the digital twin 1762, such as computing advanced analytics from the digital twin 1762 and performing simulations using the digital twin 1062. As such, the application tools 1766 may correspond to the application tools 260.

The storage 1760 may also include one or more database schemas 1770. These database schemas may store an ontology. These schemas These data schemas may include clustered data/clustered indexes 1774. Clustered data may partition the data into a known number of groups. For example, the domains partition the digital twin database data into a set of domain groups, e.g., 150a. Creating clustered schema 1774 may include hierarchical clustering or non-hierarchical clustering. Hierarchical clustering may involve creating clusters in a predefined order. The clusters are ordered in a top to bottom manner. For example, the domains, objects, attributes, etc., may be hierarchically ordered. In this type of clustering, similar clusters are grouped together and are arranged in a hierarchical manner. It can be further divided into two types namely agglomerative hierarchical clustering and divisive hierarchical clustering. The main difference between agglomerative and divisive hierarchical clustering is the direction of the clustering process. Agglomerative clustering starts with individual data points or small clusters and merges them into larger clusters, while divisive clustering begins with all data points in a single cluster and recursively divides them into smaller clusters.

In some embodiments, the clusters will be organized non-hierarchically. Non hierarchical clustering involves formation of new clusters by merging or splitting the clusters. It does not follow a tree like structure like hierarchical clustering. This technique groups the data in order to maximize or minimize some evaluation criteria.

In some embodiments a clustered index may be used. In the context of a relational database, a clustered index is a type of index that physically reorganizes the way data is stored in a table. Unlike non-clustered indexes, which store a separate data structure to map index keys to the actual data rows, a clustered index determines the physical order of the data rows in the table itself. In this sense, data is clustered based on the index key's values, meaning that the rows in the table are stored in the same order as the index key. Each table may have one clustered index because the physical organization of the data can only be based on one column or set of columns. In some embodiments there may be only a single clustered index.

In some embodiments the clusters will be ordered hierarchically. Hierarchical clusters may be used to represent hierarchical data structures. These clusters are often created to model parent-child relationships, where each data record (child) is associated with a parent record. For example, you might have a “Floor” table where each floor has a reference to the building they are in.

Hierarchical clusters may be organized in a tree-like or hierarchical structure. This means that you can navigate from a parent node to its child nodes, and you can traverse the hierarchy up and down. Each node (or data record) in the hierarchy can have one or more child nodes and at most one parent node. For example the objects within a domain may be represented as child nodes (the objects) within a parent node) the domain. These objects may have their own hierarchical grouping. For example, with reference to FIG. 1C, the Building domain objects are shown arranged hierarchically. The building object 154c within the building domain 152c contains a number of floor objects 155c, as represented by the arrow 160c. These arrows throughout the FIGURE indicate the “Contains” relationship. The object that is pointing contains objects that are being pointed to. The floor objects contain zone objects 157c. These zone objects contain surface objects 156c. The surface objects 156c contains adjacency objects 153c, and adjacency objects 153c contain surface objects. Other relationships may also be shown. For example, the Equipment domain 121c has an object, the equipment component 126c that contains building objects adjacency 153c. The site domain 122c object site 127c contains building domain building objects 154c, and so on. Different domains may display their domain-object cluster hierarchies differently.

An instance (the data associated with a specific set of objects that make up a digital twin such as a building) of a digital twin 1762 may be stored in an instance graph 1772. This instance graph 1772 may be stored using the database schema 1770. Some embodiments may have multiple digital twin instance graphs, all stored using the database schema. Using the schema, users may view data within a specific instance graph. This data may be viewed within a view of the digital twin schema.

A hierarchical view 1776 may display all of the data within a specific database grouping. For example, with reference to FIGS. 14 and 15, when a surface object 1447 is selected within a project view, the members stored within the surface data schema representation is displayed 1548 using a user interface. This display includes the individual instances of the surface objects 1548 within a given digital twin, e.g., 1762. The hierarchical view may use the members of a database table, e.g., the surface table. A view switch 1778 may be used to switch between viewing objects in a cluster, a cluster hierarchy, or a data view.

While the hardware device 1700 is shown as including one of each described component, the various components may be duplicated in various embodiments. For example, the processor 1720 may include multiple microprocessors that are configured to independently execute the methods described herein or are configured to perform steps or subroutines of the methods described herein such that the multiple processors cooperate to achieve the functionality described herein, such as in the case where the device 1700 participates in a distributed processing architecture with other devices which may be similar to device 1700. Further, where the device 1700 is implemented in a cloud computing system, the various hardware components may belong to separate physical systems. For example, the processor 1720 may include a first processor in a first server and a second processor in a second server.

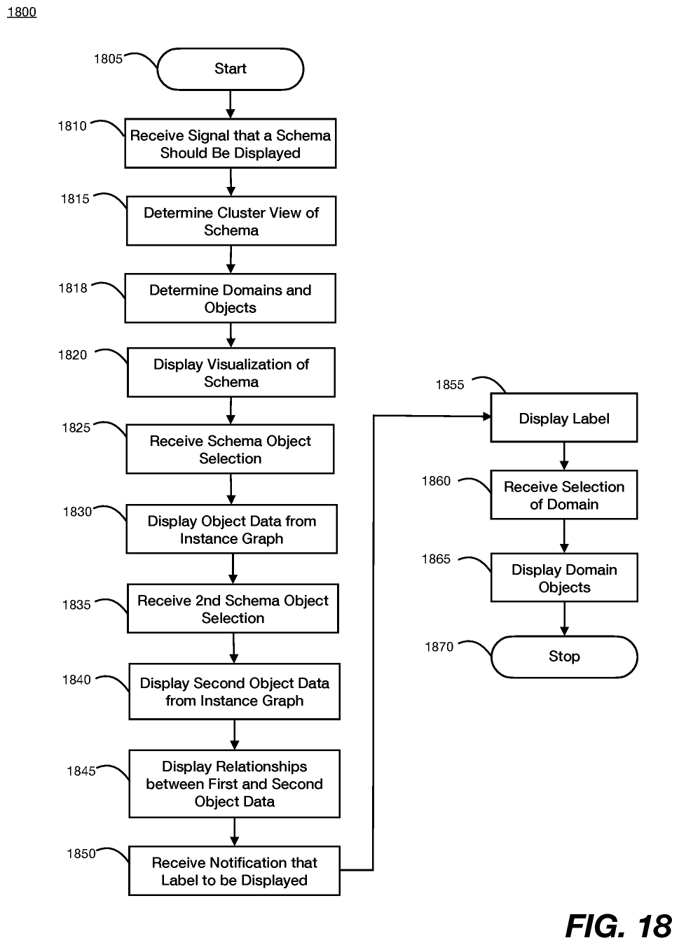

FIG. 18 illustrates an example method 1800 for displaying database schema and data from an instance of the database, the instance employing the database schema. The method 1800 may correspond to the database 212, the schema 218, the clusterer 214 or data orderer 216. In some embodiments this method may correspond to the database schema 1764, the instance graph 1772, the graphical user interface 1764, or the digital twin tools 1765. The method 1800 begins in step 1105 in response to, for example, a user creating or wishing to view an instance of a digital twin. An instance of a digital twin may be a specific running and operational copy of a database and the associated data it manages. This database may be a database holding a digital twin. The instance of the digital twin is ordered by a schema that exists separate from the instance. The schema may be a logical blueprint or structural design that defines the organization, structure, and relationships of the data within a database. At step 1810, a signal is received that a schema should be displayed. This signal may be received through a graphical user interface indicating that a user input has been received. The signal may be received through an instance of a digital twin being generated, etc. At step 1815, it is determined that a cluster view of the schema should be displayed. The cluster view of the schema may be fetched from the database to be displayed, using for example, the clusterer 1774. In embodiments, there may be a schema already rendered that is ready to be displayed, which may be held in the clusterer 1774, storage 1760, etc. The cluster view of the schema may be the view in the ontology graph explorer 140a showing domains of a digital twin, with the domains represented by icons, and the connections between the domains represented by connection lines. This cluster view of the schema may be a view of a specific domain with the connection between the objects indicated using connection lines as shown with reference to FIG. 1C. To assemble the cluster view, at step 1818, the domains of the schema may be collected, if a ontology graph explorer view 140a has been requested. If another user input is received indicating that a specific domain should be opened, then the objects associated with that domain may be collected so that they can be displayed, as shown with reference to 151a. When a single domain is selected, such as with reference to FIG. 1C, then the objects associated with the selected domain and their connections should be collected. At 1820, a visualization of the schema with the required domains or objects is displayed. At 1825, an object within the schema is selected. This selection may be a selection of an object with an icon representation within a project view. Such a project view is shown with reference to FIG. 12. the objects floor 1282, zone 1284, etc. may be selected. For example, a floor object 1282 may be selected. At 1830, data from the current instance graph that corresponds to the selected object may be displayed. For example, with reference to FIG. 14, after the floor object has been selected, the instances of the floor object 1440 in the current instance of the digital twin may be displayed. At 1835, a second schema object may be selected. For example, the zone schema object 1284 may be selected. At 1840, another set of object data may be displayed. In the instant example, the zones associated with the current instance of the digital twin database may be displayed. Here 22 zones 1446 are associated with the Bldg 1 instance 1443. At 1845, relationships between the first object and the second object are displayed. In the instant example, Floor 2 is associated with four zones; to indicate this, in this embodiment, lines 1448 are drawn from the floor instance Floor 2 1445 to each associated zone. At 1850 a notification is received that a label is to be displayed. With reference to FIG. 16, a line may be selected to have a label shown. This selection may include having a cursor hover over the line. At 1855 the label is displayed 1660. At 1860 a selection of a domain is received. With reference to FIG. 1A, the “Building” domain 152a may be selected in a left-hand panel 150a. At 1865, the objects associated with the domain are displayed 151a. At step 1870, the method ends.

It should be apparent from the foregoing description that various example embodiments of the invention may be implemented in hardware or firmware. Furthermore, various exemplary embodiments may be implemented as instructions stored on a machine-readable storage medium, which may be read and executed by at least one processor to perform the operations described in detail herein. A non-transitory machine-readable storage medium may include any mechanism for storing information in a form readable by a machine, such as a personal or laptop computer, a mobile device, a tablet, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain example aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the scope of the claims.

1. A method performed by a processer with a memory for displaying a database schema on a user interface, comprising:
displaying a first visualization of a database schema on a user interface, the first visualization showing a high-level view of the database schema;
receiving an indication from the user interface that a schema component of the database schema has been chosen;
while the first visualization is displayed, displaying a second visualization of the schema component on the user interface, the second visualization showing a low-level view of a portion of the database schema; and
while the first visualization is displayed, displaying relationships between the database schema and the schema component on the user interface.

2. (canceled)

3. (canceled)

4. (canceled)

5. The method of claim 1, wherein the first second visualization of the schema component is a hierarchical cluster view of at least a portion of the database schema.

6. The method of claim 5, wherein the second visualization displays data associated with an instance of the database schema.

7. (canceled)

8. The method of claim 1, wherein the database schema is a digital twin schema.

9. The method of claim 8, wherein the digital twin schema comprises domains, and wherein the domains comprise objects.

10. A non-transitory machine-readable medium encoded with instructions for execution by a processor for viewing a database schema, the non-transitory machine-readable medium comprising:
instructions for displaying a first visualization of the database schema on a user interface, the first visualization showing a high-level view of the database schema;
instructions for receiving an indication from the user interface that a schema component associated with the database schema has been chosen;
instructions for displaying a second visualization of the schema component on the user interface while the first visualization is displayed, the second visualization showing a low-level view of a portion of the database schema hierarchy; and
instructions for displaying a relationship between the database schema and the schema component on the user interface while the first visualization is displayed.

11. The non-transitory machine-readable medium of claim 10, wherein instructions for displaying the first visualization of a database schema on the user interface comprises instructions for displaying domains associated with a digital twin associated with the database schema.

12. (canceled)

13. The non-transitory machine-readable medium of claim 11, wherein instructions for displaying relationships between the database schema and the schema component on the user interface comprise while the first visualization is displayed, displaying at least one data object associated with an instance of the database schema, while the first visualization is displayed, displaying at least one data object associated with an instance of the schema component with a relationship with the database schema, and while the first visualization is displayed, displaying a visual marking of the relationship between the database schema and the schema component.

14. The non-transitory machine-readable medium of claim 13, wherein the visual marking of the relationship between the database schema and the schema component comprise displaying a line between the first visualization and the second visualization.

15. The non-transitory machine-readable medium of claim 14, wherein the visual marking of the relationship between the database schema and the schema component further comprises displaying a label indicating a name of the database schema and a name of the schema component.

16. A device for viewing a database schema, the device comprising:
a memory storing descriptions of the database schema for an ontology, and
a processor in communication with the memory configured to:
display a first visualization of the database schema on a user interface, the first visualization showing a high-level view of the database schema;
receive an indication from the user interface that a schema component has been chosen;
while the first visualization is displayed, display a second visualization of the schema component on the user interface, the second visualization showing a low-level view of a portion of the database schema; and
while the first visualization is displayed, displaying relationships between the first visualization of the database schema and the second visualization of the schema component.

17. (canceled)

18. The device of claim 16, further comprising the database schema comprising a schema of a digital twin, data in an instance of the a digital twin stored in memory, and wherein the second visualization includes a visualization of at least some of the data in the instance of the digital twin.

19. The device of claim 18, wherein first schema comprises a hierarchical cluster view first schema of objects, and the schema component comprises second schema data about at least some of the objects associated with the hierarchical cluster view, and wherein when displaying relationships, the processor is configured to draw a line between a display of a first schema hierarchical cluster object and a display of the second schema data about at least some of the objects when there is a relationship between the first schema objects and the second schema objects.

20. (canceled)

21. The method of claim 9, further comprising receiving an indication from the user interface that an object has been selected, and while the second visualization is at displayed at least in part, displaying a third visualization.

22. The method of claim 21, wherein the third visualization comprises data associated with the object.

23. The method of claim 22, wherein the data associated with the object comprises at least one relation between the object and the schema component.

24. The method of claim 23, wherein the data associated with the schema component comprises quanta type.

25. The method of claim 24, wherein the quanta type comprises gas, fluid, thermal, wired, or mechanical.

26. The device of claim 16, further comprising displaying a visual marking of the relationship between the database schema and the schema component; and wherein the visual marking of the relationship between the database schema and the schema component comprise displaying a line between the first visualization and the second visualization.

27. The device of claim 26, wherein the visual marking of the relationship between the database schema and the schema component further comprises displaying a label indicating a name of the database schema and a name of the schema component.
